(19) United States
(12) Patent Application Publication
(10) Pub. No.: US 2010/0091033 A1
(43) Pub. Date: Apr. 15, 2010

(54) IMAGE PROCESSING APPARATUS, IMAGE DISPLAY AND IMAGE PROCESSING METHOD

(75) Inventors: Tomohiko Itoyama, Chiba (JP); Toshio Sarugaku, Chiba (JP); Hiroshi Sugisawa, Kanagawa (JP); Tomoya Yano, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/450,230

(22) PCT Filed: Mar. 12, 2008
(86) PCT No.: PCT/JP2008/054471

§ 371 Date: Sep. 15, 2009

(30) Foreign Application Priority Data
Mar. 16, 2007 (JP) 2007-069326
Mar. 16, 2007 (JP) 2007-069327
Mar. 20, 2007 (JP) 2007-072171

(51) Int. Cl. G09G 5/02; G09G 3/36

(52) U.S. Cl. 345/600; 345/89

(57) ABSTRACT

An image processing apparatus capable of achieving compatibility between extension of a viewing angle characteristic and an improvement in motion picture response while reducing a sense of flicker in an image display having a sub-pixel configuration is provided. The image processing apparatus includes: a detection means for detecting a motion index and/or an edge index of an input picture for each pixel; a frame division means for dividing a unit frame period of the input picture into a plurality of sub-frame periods; and a gray-scale conversion means for selectively performing adaptive gray-scale conversion on luminance in a pixel where a motion index and/or an edge index larger than a predetermined threshold value is detected so that, while allowing the time integral value of the luminance signal within the unit frame period to be maintained as it is, a high luminance period and a low luminance period are allocated to sub-frame periods in the unit frame period, respectively. The gray-scale conversion means performs adaptive gray-scale conversion on luminance for each sub-pixel so that the plurality of sub-pixels in each pixel have different display luminance from each other.

### TECHNICAL FIELD

The present invention relates to an image processing apparatus and an image processing method which are suitably applied to a hold-type image display or an image display configured so that each pixel includes a plurality of sub-pixels, and an image display including such an image processing apparatus.

### BACKGROUND ART

As means for improving motion picture response by performing pseudo-impulse display by an image display (for example, a liquid crystal display (LCD)) which performs hold-type display, black insertion techniques such as black frame insertion or backlight blinking are widely used in commercially available LCDs. However, in these techniques, a black insertion ratio is increased to improve an effect of improving motion picture response, so there is an issue that display luminance becomes lower with increasing a black insertion ratio.

Therefore, for example, in Patent Document 1, a pseudo-impulse display method capable of improving motion picture response without sacrificing display luminance (hereinafter referred to as improved pseudo-impulse drive) is proposed. In this method, in the case where an input gray scale (a luminance gradation level of a picture signal) is temporally changed as illustrated in FIG. 39 (timings t100 to t105), adaptive gray-scale conversion is performed so that a unit frame period of a picture signal is divided into two sub-frame periods (for example, a unit frame period with a normal display frame rate of 60 Hz is divided into two sub-frame periods with a frame rate of 120 Hz which is twice as high as the normal display frame rate), and an (input/output) gray-scale conversion characteristic γ100 illustrated in FIG. 40 is divided into a gray-scale conversion characteristic γ101H corresponding to a sub-frame period 1 and a gray-scale conversion characteristic γ101L corresponding to a sub-frame period 2. Then, when average luminance (a time integral value of luminance) in the unit frame period is maintained before and after gray-scale conversion, as illustrated in FIG. 41 (timings t200 to t210), pseudo-impulse drive is capable of being performed without sacrificing display luminance, and low motion picture response caused by hold-type display is overcome.

On the other hand, as a technique other than this, in the above-described Patent Document 1, to improve a viewing angle characteristic in an image display, an image display with a sub-pixel configuration in which each pixel includes a plurality of sub-pixels has been also proposed.

[Patent Document 1] International Publication No. 2006/009106 pamphlet

### DISCLOSURE OF THE INVENTION

Here, to improve motion picture response, also in an image display with such a sub-pixel configuration, it is considered to perform improved pseudo-impulse drive as in the case of the above-described Patent Document 1.

However, in the improved pseudo-impulse drive, there is an issue that when the transmittance of a liquid crystal is changed in response to the pseudo-impulse drive as illustrated in FIG. 42 (timings t300 to 310), a change in the transmittance of the liquid crystal appears just like a normal frame rate, and flicker at the normal frame rate is observed.

Therefore, to reduce a sense of flicker caused by such improved pseudo-impulse drive, it is considered that, for example, as in the case of gray-scale conversion characteristics γ102H and γ102L illustrated in FIG. 40, a gray-scale conversion characteristic is brought close to an original linear gray-scale conversion characteristic γ100. However, in such gray-scale conversion characteristics γ102H and γ102L, compared to gray-scale conversion characteristics γ101H and γ101L, the response of the liquid crystal is also returned in a direction from pseudo-impulse response to hold response, so an effect of improving motion picture response which is an original effect of improved pseudo-impulse is also reduced. In other words, a reduction in the sense of flicker and an improvement in motion picture response have a trade-off relationship with each other. Moreover, in particular, in the case where a picture signal is a low frame rate signal such as PAL (Phase Alternation Line), the sense of flicker obviously appears, so when a gray-scale conversion characteristic capable of perfectly eliminating the sense of flicker is selected, the effect of improving motion picture response is reduced to an extent to which the effect is hardly recognizable. Further, an effect by the sub-pixel configuration in which the gray-scale conversion characteristic is brought close to the original linear gray-scale conversion characteristic γ100 (a wide viewing angle characteristic) is also reduced.

Thus, in the techniques in related art, in the case where an improved pseudo-impulse configuration is applied to the sub-pixel configuration, it is difficult to achieve compatibility between extension of the viewing angle characteristic and an improvement in motion picture response while reducing a sense of flicker.

Moreover, as described above, there is an issue that in the improved pseudo-impulse drive, when the transmittance of a liquid crystal is changed in response to the pseudo-impulse drive, a change in the transmittance of the liquid crystal appears just like a normal frame rate, and flicker at the normal frame rate is observed.

Therefore, it is considered that the above-described improved pseudo-impulse drive is not uniformly applied to the whole screen, but is selectively applied to a portion where it is desired to improve motion picture response (for example, an edge portion of an motion picture). In such a case, a configuration in which motion information or edge information for each pixel is detected, and the improved pseudo-impulse drive is selectively performed on the basis of the detection result is considered.

However, in such a configuration, when irregular motion occurs in a picture subjected to processing, or when a too large noise component superimposes on a picture signal, temporal discontinuity in the strength of motion information or edge information may occur. Then, when such discontinuity occurs, a gray-scale expression balance by a combination of light and dark gray scales in improved pseudo-impulse drive is lost, and as a result, a noise or flicker may occur in a displayed picture to cause degradation in picture quality.

Further, as described above, there is an issue that in the improved pseudo-impulse drive, when the transmittance of a liquid crystal is changed in response to the pseudo-impulse drive, a change in the transmittance of the liquid crystal appears just like a normal frame rate, and flicker at the normal frame rate is observed.

Therefore, as described above, it is considered that the above-described improved pseudo-impulse drive is not uniformly applied to the whole screen, but is selectively applied to a portion where it is desired to improve motion picture response (for example, an edge portion of an motion picture).

Here, in such a configuration, even if a sub-frame period in which normal drive is performed and a sub-frame period in which improved pseudo-impulse drive is performed have original picture signals with the same luminance level, the sub-frame periods have different luminance levels from each other after adaptive gray-scale conversion, so an appropriate overdrive amount for each pixel is desirably set depending on a transition mode between drive systems to perform optimum overdrive irrespective of transition modes (to cause optimum overshoot). It is because when an overshoot amount is not set appropriately, the response of a liquid crystal in the pixel becomes slower, so the effect of improving motion picture response by improved pseudo-impulse drive is not sufficiently exerted.

The present invention is made to solve the above-described issues, and it is a first object of the invention to provide an image processing apparatus, an image display and an image processing method which are capable of achieving compatibility between expansion of a viewing angle characteristic and an improvement in motion picture response while reducing a sense of flicker in an image display having a sub-pixel configuration.

Moreover, it is a second object of the invention to provide an image processing apparatus, an image display and an image processing method which are capable of achieving compatibility between a reduction in a sense of flicker and an improvement in motion picture response irrespective of contents of a video picture or the presence or absence of a noise component.

Further, it is a third object of the invention to provide an image processing apparatus, an image display and an image processing method which are capable of effectively improving motion picture response while reducing a sense of flicker.

A first image processing apparatus of the invention is applied to an image display configured so that each pixel includes a plurality of sub-pixels, and includes a detection means for detecting a motion index and/or an edge index of an input picture for each pixel; a frame division means for dividing a unit frame period of the input picture into a plurality of sub-frame periods; and a gray-scale conversion means. In this case, the gray-scale conversion means selectively performs adaptive gray-scale conversion on a luminance signal in a pixel region where a motion index or an edge index larger than a predetermined threshold value is detected from the luminance signal of the input picture by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively, and performs adaptive gray-scale conversion for each sub-pixel so that the plurality of sub-pixels in each pixel have different display luminance from each other.

A first image display of the invention includes the above-described detection means, the above-described division means, the above-described gray-scale conversion means and a display means configured so that each pixel includes a plurality of sub-pixels, and for displaying a picture on the basis of a luminance signal subjected to adaptive gray-scale conversion by the gray-scale conversion means.

A first image processing method of the invention is applied to an image display configured so that each pixel includes a plurality of sub-pixels, and includes: a detection step of detecting a motion index and/or an edge index of an input picture for each pixel; a frame division step of dividing a unit frame period of the input picture into a plurality of sub-frame periods; and a gray-scale conversion step. In this case, in the gray-scale conversion step, adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively, and adaptive gray-scale conversion is performed for each sub-pixel so that the plurality of sub-pixels in each pixel have different display luminance from each other.

In the first image processing apparatus, the first image display and the first image processing method of the invention, a motion index and/or a edge index of an input picture is detected for each pixel, and a unit frame period of the input picture is divided into a plurality of sub-frame periods. Then, adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively. Adaptive gray-scale conversion is selectively performed on the luminance signal in the pixel region where the motion index or the edge index is larger than the predetermined threshold value in such a manner, so motion picture response is improved by pseudo-impulse drive, and compared to the case where adaptive gray-scale conversion is performed on luminance signals in all pixel regions as in the case of related art, a sense of flicker is reduced. Moreover, adaptive gray-scale conversion is performed for each sub-pixel so that the plurality of sub-pixels in each pixel have different display luminance from each other, so adaptive gray-scale conversion suitable for different display luminance of each sub-pixel is possible.

In the first image processing apparatus of the invention, the above-described gray-scale conversion means is configurable to convert the luminance signal of the input picture for each pixel into luminance signals for the sub-pixels while allowing a space integral value to be maintained as it is, and is able to perform the adaptive gray-scale conversion on each of the luminance signals for the sub-pixels. Moreover, conversely, the above-described gray-scale conversion means may perform the adaptive gray-scale conversion on the luminance signal of the input picture, and may convert the luminance signal subjected to the adaptive gray-scale conversion for each pixel into luminance signals for the sub-pixels while allowing a space integral value to be maintained as it is. In the latter case, after performing the adaptive gray-scale conversion on the luminance signal of the input picture, the luminance signal is converted into the luminance signals for the sub-pixels, so compared to the former case in which after the luminance signal of the input picture is converted into the luminance signals for the sub-pixels, adaptive gray-scale conversion is performed for each sub-pixel, an apparatus configuration is simplified.

In the first image processing apparatus of the invention, the gray-scale conversion characteristic of each sub-pixel is preferably established so that a difference in display luminance between sub-pixels in each pixel approaches a predetermined threshold value. In such a configuration, the viewing angle characteristic is further improved with increase in a difference in display luminance between sub-pixels.

A second image processing apparatus of the invention includes: a detection means for detecting a motion index and/or an edge index of an input picture for each pixel; a determination means for determining the presence or absence of discontinuity along a time axis in the detected motion index and the detected edge index for each pixel; a correction means for, in the case where the presence of discontinuity in the motion index or the edge index is determined by the determination means, correcting the motion index and the edge index for each pixel so as to eliminate the discontinuity; a frame division means for dividing a unit frame period of the input picture into a plurality of sub-frame periods; and a gray-scale conversion means. In this case, the gray-scale conversion means selectively performs, on the basis of the motion index and the edge index subjected to correction by the correction means, adaptive gray-scale conversion on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively.

A second image display of the invention includes the above-described detection means; the above-described determination means; the above-described correction means; the above-described frame division means; the above-described gray-scale conversion means; and a display means for displaying a picture on the basis of a luminance signal subjected to adaptive gray-scale conversion by the gray-scale conversion means.

A second image processing method of the invention includes: a detection step of detecting a motion index and/or an edge index of an input picture for each pixel; a determination step of determining the presence or absence of discontinuity along a time axis in the detected motion index and the detected edge index for each pixel; a correction step of, in the case where the presence of discontinuity in the motion index or the edge index is determined, correcting the motion index and the edge index for each pixel so as to eliminate the discontinuity; a frame division step of dividing a unit frame period of the input picture into a plurality of sub-frame periods; and a gray-scale conversion step. In the gray-scale conversion step, adaptive gray-scale conversion is selectively performed, on the basis of the motion index and the edge index subjected to correction, on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively.

In the second image processing apparatus, the second image display and the second image processing method of the invention, a motion index and/or an edge index of an input picture is detected for each pixel, and a unit frame period of the input picture is divided into a plurality of sub-frame periods. Then, adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively. Adaptive gray-scale conversion is selectively performed on the luminance signal in the pixel region where the motion index or the edge index is larger than the predetermined threshold value in such a manner, so motion picture response is improved by pseudo-impulse drive, and compared to the case where adaptive gray-scale conversion is performed on luminance signals in all pixel regions as in the case of related art, a sense of flicker is reduced. Moreover, the presence or absence of discontinuity along a time axis in the detected motion index and the detected edge index is determined for each pixel, and in the case where the presence of discontinuity in the motion index or the edge index is determined, the motion index and the edge index are corrected for each pixel so as to eliminate the discontinuity, so irrespective of contents of a picture or the presence or absence of a noise component, continuity along the time axis in the motion index or the edge index is maintained.

In the second image processing apparatus of the invention, in the case where the presence of discontinuity in only one of the motion index and the edge index is determined, the above-described correction means preferably performs correction so as to eliminate the discontinuity, and on the other hand, in the case where the presence of discontinuity in both of the motion index and the edge index is determined, the above-described correction means does not preferably perform correction. In such a configuration, even in the case where discontinuity is present in only one of the motion index and the edge index due to a noise or the like, correction is prevented from being mistakenly performed. In other words, determination whether discontinuity supposed to be corrected is undoubtedly present or not in the motion index or the edge index is able to be made, so the discontinuity determination accuracy is improved.

A third image processing apparatus of the invention includes: a detection means for detecting a motion index and/or an edge index of an input picture for each pixel; a frame division means for dividing a unit frame period of the input picture into a plurality of sub-frame periods; a gray-scale conversion means, a determination means; and an addition means. In this case, the above-described gray-scale conversion means selectively performs adaptive gray-scale conversion on a luminance signal in a pixel region where a motion index or an edge index larger than a predetermined threshold value is detected from the luminance signal of the input picture by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively. Moreover, the above-described determination means determines, one after another for each pixel, a following state transition mode among a plurality of state transition modes each defined as a state transition mode between any two of a normal luminance state, a high luminance state and a low luminance state, the normal luminance state being established by the original luminance signal, the high luminance state being established in the high luminance period, the low luminance state being established in the low luminance period. Further, the above-described addition means adds, for each pixel, an overdrive amount according to a determined state transition mode onto a luminance signal subjected to adaptive gray-scale conversion by the gray-scale conversion means.

A third image display of the invention includes the above-described detection means; the above-described frame division means; the above-described gray-scale conversion means; the above-described determination means; the above-described addition means; and a display means for displaying a picture on the basis of a luminance signal subjected to addition of the overdrive amount by the addition means.

A third image processing method of the invention includes: a detection step of detecting a motion index and/or an edge index of an input picture for each pixel; a frame division step of dividing a unit frame period of the input picture into a plurality of sub-frame periods; a gray-scale conversion step; a determination step; and an addition step. In this case, in the above-described gray-scale conversion step, adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively. Moreover, in the determination step, a following state transition mode among a plurality of state transition modes each defined as a state transition mode between any two of a normal luminance state, a high luminance state and a low luminance state is determined one after another for each pixel, and the normal luminance state being established by the original luminance signal, the high luminance state being established in the high luminance period, the low luminance state being established in the low luminance period. Further, in the above-described addition step, an overdrive amount according to a determined state transition mode is added, for each pixel, onto a luminance signal subjected to adaptive gray-scale conversion.

In the third image processing apparatus, the third image display and the image processing method of the invention, a motion index and/or an edge index of an input picture is detected for each pixel, and a unit frame period of the input picture is divided into a plurality of sub-frame periods. Then, adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively. Adaptive gray-scale conversion is selectively performed on the luminance signal in the pixel region where the motion index or the edge index is larger than the predetermined threshold value in such a manner, so motion picture response is improved by pseudo-impulse drive, and compared to the case where adaptive gray-scale conversion is performed on luminance signals in all pixel regions as in the case of related art, a sense of flicker is reduced. Moreover, a following state transition mode among a plurality of state transition modes is determined one after another for each pixel, and an overdrive amount according to a determined state transition mode is added, for each pixel, onto a luminance signal subjected to adaptive gray-scale conversion, so an appropriate overdrive amount according to the state transition mode is able to be added.

According to the first image processing apparatus, the first image display or the first image processing method of the invention, a motion index and/or a edge index of the input picture is detected for each pixel, and a unit frame period of the input picture is divided into a plurality of sub-frame periods, and adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively, so motion picture response is able to be improved by pseudo-impulse drive, and compared to the case where adaptive gray-scale conversion is performed on luminance signals in all pixel regions as in the case of related art, a sense of flicker is able to be reduced. Moreover, adaptive gray-scale conversion is performed for each sub-pixel so that the plurality of sub-pixels in each pixel have different display luminance from each other, so adaptive gray-scale conversion suitable for different display luminance of each sub-pixel is possible, and the viewing angle characteristic is able to be improved. Therefore, in the image display with a sub-pixel configuration, while the sense of flicker is reduced, compatibility between extension of the viewing angle characteristic and an improvement in motion picture response is able to be achieved.

Moreover, according to the second image processing apparatus, the second image display or the second image processing method of the invention, a motion index and/or an edge index of an input picture is detected for each pixel, and a unit frame period of the input picture is divided into a plurality of sub-frame periods, and adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively, so motion picture response is able to be improved by pseudo-impulse drive, and compared to the case where adaptive gray-scale conversion is performed on luminance signals in all pixel regions as in the case of related art, a sense of flicker is able to be reduced. Moreover, the presence or absence of discontinuity along a time axis in the detected motion index and the detected edge index is determined for each pixel, and in the case where the presence of discontinuity in the motion index or the edge index is determined, the motion index and the edge index are corrected for each pixel so as to eliminate the discontinuity, so irrespective of contents of a picture or the presence or absence of a noise component, continuity along the time axis in the motion index or the edge index is able to be maintained. Therefore, irrespective of contents of the picture or the presence or absence of the noise component, compatibility between a reduction in the sense of flicker and an improvement in motion picture response is able to be achieved.

Further, according to the third image processing apparatus, the third image display or the third image processing method of the invention, a motion index and/or an edge index of an input picture is detected for each pixel, and a unit frame period of the input picture is divided into a plurality of sub-frame periods, and adaptive gray-scale conversion is selectively performed on a luminance signal in a pixel region where a motion index or an edge index larger than a predetermined threshold value is detected from the luminance signal of the input picture so that, while allowing the time integral value of the luminance signal within the unit frame period to be maintained as it is, a high luminance period and a low luminance period are allocated to sub-frame periods in the unit frame period, respectively, so motion picture response is able to be improved by pseudo-impulse drive, and compared to the case where adaptive gray-scale conversion is performed on luminance signals in all pixel regions as in the case of related art, a sense of flicker is able to be reduced. Moreover, a following state transition mode among a plurality of state transition modes is determined one after another for each pixel, and an overdrive amount according to a determined state transition mode is added, for each pixel, onto a luminance signal subjected to adaptive gray-scale conversion, so an appropriate overdrive amount according to the state transition mode is able to be added, and irrespective of the state transition mode, optimum overdrive is able to be performed. Therefore, while reducing the sense of flicker, the motion picture response is able to be effectively improved.

### BRIEF DESCRIPTION OF THE DRAWINGS

FIG. 1 is a black diagram illustrating the whole configuration of an image display including an image processing apparatus according to a first embodiment of the invention.

FIG. 2 is a plot for describing a luminance γ characteristic at the time of sub-pixel drive conversion illustrated in FIG. 1.

FIG. 3 is a plot for describing a luminance γ characteristic at the time of gray-scale conversion in a sub-pixel 1 illustrated in FIG. 2.

FIG. 4 is a plot for describing a luminance γ characteristic at the time of gray-scale conversion in a sub-pixel 2 illustrated in FIG. 2.

FIG. 5 is a flowchart illustrating a method of adjusting a luminance γ characteristic in each sub-pixel.

FIG. 6 is a timing waveform chart for describing operation of a sub-pixel drive conversion section illustrated in FIG. 1.

FIG. 7 is a schematic view for describing operation of a processing region detection section illustrated in FIG. 1.

FIG. 8 is a drawing collectively illustrating a relationship between a drive method and a method of converting a luminance signal according to the first embodiment.

FIG. 9 is a timing waveform chart for describing the operation of each gray-scale conversion section illustrated in FIG. 1.

FIG. 10 is a block diagram illustrating the whole configuration of an image display including an image processing apparatus according to a second embodiment of the invention.

FIG. 11 is a drawing collectively illustrating a relationship between a drive method and a method of converting a luminance signal according to the second embodiment.

FIG. 12 is a block diagram illustrating the whole configuration of an image display including an image processing apparatus according to a third embodiment of the invention.

FIG. 13 is a plot for describing a luminance γ characteristic at the time of gray-scale conversion by a gray-scale conversion section illustrated in FIG. 12.

FIG. 14 is a block diagram illustrating a specific configuration of a discontinuity detection/correction section illustrated in FIG. 12.

FIG. 15 is a schematic view for describing basic operation of a processing region detection section illustrated in FIG. 12.

FIG. 16 is a timing waveform chart illustrating an input/output characteristic of a luminance signal before gray-scale conversion.

FIG. 17 is a timing waveform chart illustrating an input/output characteristic of a luminance signal after gray-scale conversion.

FIG. 18 is a block diagram illustrating the whole configuration of an image display including an image processing apparatus according to a comparative example to the third embodiment.

FIG. 19 is a timing chart for describing a state in the case where discontinuity is detected in motion information and edge information in the comparative example to the third embodiment.

FIG. 20 is a timing chart for describing operation of the discontinuity detection/correction section.

FIG. 21 is a timing chart illustrating an example of an effect of eliminating discontinuity by the discontinuity detection/correction section.

FIG. 22 is a timing chart illustrating another example of the effect of eliminating discontinuity by the discontinuity detection/correction section.

FIG. 23 is a drawing for describing a relationship between a discontinuity detection result and need for correction in motion information and edge information according to a modification example of the third embodiment.

FIG. 24 is a block diagram illustrating the whole configuration of an image display including an image processing apparatus according to a fourth embodiment of the invention.

FIG. 25 is a plot illustrating a luminance γ characteristic at the time of gray-scale conversion by a gray-scale conversion section illustrated in FIG. 24.

FIG. 26 is a timing waveform chart illustrating an input/output characteristic of a luminance signal before gray-scale conversion.

FIG. 27 is a timing waveform chart illustrating an input/output characteristic of a luminance signal after gray-scale conversion.

FIG. 28 is a schematic view for describing a state transition mode according to the fourth embodiment.

FIG. 29 is a timing waveform chart for describing a basic process of overdrive correction.

FIG. 30 is a block diagram illustrating a specific configuration of an overdrive correction section illustrated in FIG. 24.

FIG. 31 is a drawing illustrating an example of a lookup table (LUT) used in each LUT processing section illustrated in FIG. 30.

FIG. 32 is a schematic view for describing operation of a processing region detection section illustrated in FIG. 24.

FIG. 33 is a drawing illustrating an example of a true table used in a selector illustrated in FIG. 30.

FIG. 34 is a timing waveform chart illustrating an example of state transition of a luminance signal according to the fourth embodiment.

FIG. 35 is a schematic view for describing a state transition mode according to a modification example of the fourth embodiment.

FIG. 36 is a schematic view for describing a state transition mode according to another modification example of the fourth embodiment.

FIG. 37 is a timing waveform chart illustrating an example of state transition of a luminance signal according to the modification example illustrated in FIG. 35.

FIG. 38 is a timing waveform chart illustrating an example of state transition of a luminance signal according to the modification example illustrated in FIG. 36.

FIG. 39 is a timing waveform chart illustrating an input/output characteristic of a luminance signal before gray-scale conversion in an image processing method in related art.

FIG. 40 is a plot illustrating a luminance γ characteristic at the time of gray-scale conversion according to the image processing method in related art.

FIG. 41 is a timing waveform chart illustrating an input/output characteristic of a luminance signal after gray-scale conversion in the image processing method in related art.

FIG. 42 is a timing waveform chart illustrating a temporal change in transmittance of a liquid crystal display panel after gray-scale conversion in the image processing method in related art.

### BEST MODE(S) FOR CARRYING OUT THE INVENTION

Embodiments of the present invention will be described in detail below referring to the accompanying drawings.

### First Embodiment

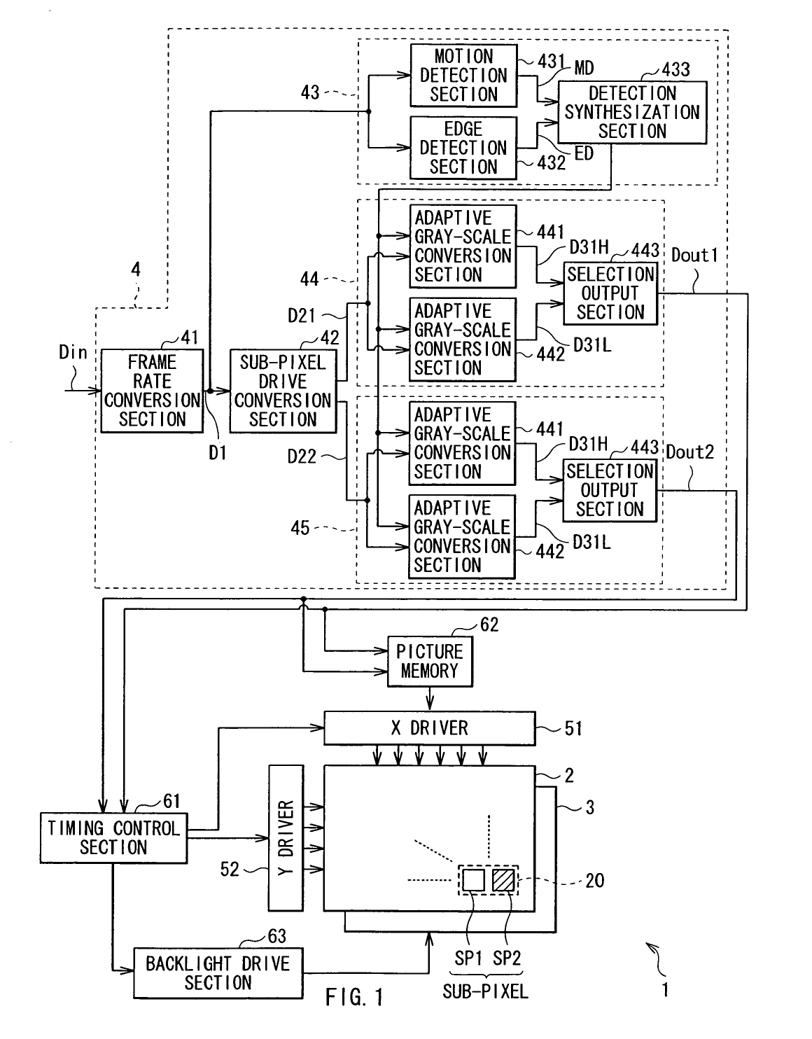

FIG. 1 illustrates the whole configuration of an image display (a liquid crystal display 1) including an image processing apparatus (an image processing section 4) according to a first embodiment of the invention. The liquid crystal display 1 includes a liquid crystal display panel 2, a backlight section 3, the image processing section 4, a picture memory 62, an X driver 51, a Y driver 52, a timing control section 61 and a backlight control section 63. In addition, an image processing method according to the embodiment is embodied by the image processing apparatus according to the embodiment, and will be also described below.

The liquid crystal display panel 2 displays a picture corresponding to a picture signal Din by a drive signal supplied from the X driver 51 and the Y driver 52 which will be described later, and includes a plurality of pixels 20 arranged in a matrix form. Moreover, each pixel 20 includes two sub-pixels SP1 and SP2, thereby as will be described in detail later, the viewing angle characteristic of the liquid crystal display 1 is improved. In addition, these two sub-pixels SP1 and SP2 have different liquid crystal visual characteristics from each other.

The backlight section 3 is a light source applying light to the liquid crystal display panel 2, and includes, for example, a CCFL (Cold Cathode Fluorescent Lamp), an LED (Light Emitting Diode) or the like.

The image processing section 4 performs predetermined image processing which will be described later on the picture signal Din (a luminance signal) from outside to generate picture signals Dout1 and Dout2 for the sub-pixels SP1 and SP2 of each pixel 20, respectively, and includes a frame rate conversion section 41, a sub-pixel drive conversion section 42, a conversion region detection section 43 and two gray-scale conversion sections 44 and 45.

The frame rate conversion section 41 converts the frame rate (for example, 60 Hz) of the picture signal Din into a higher frame rate (for example 120 Hz). Specifically, the unit frame period (for example, ( 1/60) seconds) of the picture signal Din is divided into a plurality of (for example, two) sub-frame periods (for example, ( 1/120) seconds) to generate a picture signal D1 (a luminance signal) consisting of, for example, two sub-frame periods. In addition, as a method of generating the picture signal D1 by such frame rate conversion, for example, a method of producing an interpolation frame by motion detection or a method of producing an interpolation frame by simply duplicating the original picture signal Din is considered.

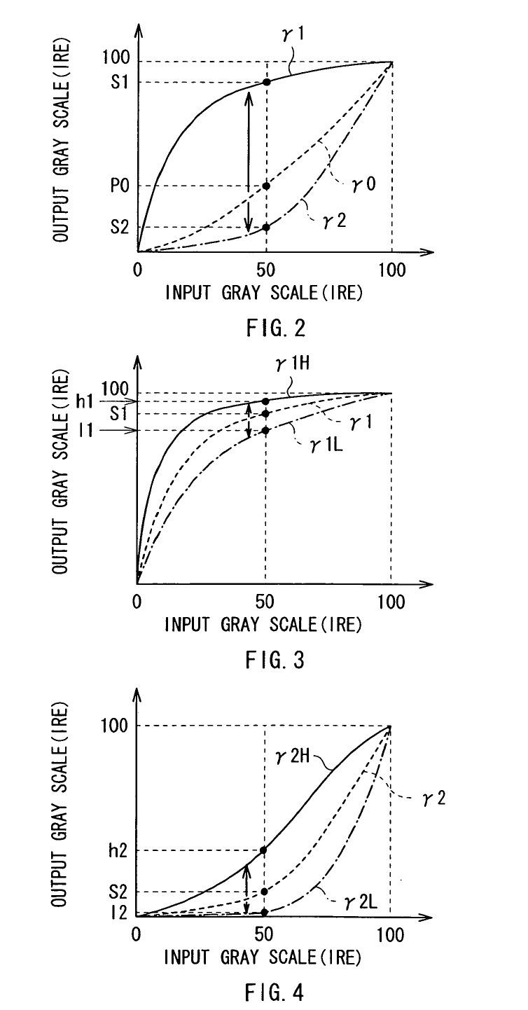

The sub-pixel drive conversion section 42 performs gray-scale conversion on the picture signal D1 supplied from the frame rate conversion section 41 to generate picture signals (luminance signals) D21 and D22 for two sub-pixel SP1 and SP2, respectively, while maintaining the space integral value of display luminance. Specifically, for example, in the case where the (input/output) gray-scale conversion characteristic (the luminance γ characteristic) of the picture signal D1 is a luminance γ characteristic γ0 (for example, a nonlinear γ2.2 curve) illustrated in FIG. 2, gray-scale conversion is performed so that the luminance γcharacteristic γ0 is divided into two luminance γ characteristics γ1 and γ2 for two sub-pixels SP1 and SP2, respectively. In addition, the luminance γ characteristics in the sub-pixels SP1 and SP2 will be described in detail later.

The conversion region detection section 43 detects motion information (a motion index) MD and edge information (an edge index) ED for each pixel 20 in each sub-frame period from the picture signal D1 supplied from the frame rate conversion section 41, and includes a motion detection section 431, an edge information detection section 432 and a detection synthesization section 433. The motion detection section 431 detects motion information MD for each pixel 20 in each sub-frame period from the picture signal D1, and an edge detection section 432 detects edge information for each pixel 20 in each sub-frame period from the picture signal D1. Moreover, the detection synthesization section 433 combines the motion information MD detected by the motion detection section 431 and the edge information ED detected by the edge detection section 432, and generates and outputs a detection synthesization result signal DCT by performing various adjustment processes (a detection region expanding process, a detection region rounding process, an isolated point detection process or the like). In addition, as a motion detection method by the motion detection section 431, for example, a method of detecting a motion vector through the use of a block matching method, a method of detecting a motion vector between sub-frames through the use of a difference signal between sub-frames, or the like is cited. Moreover, as an edge detection method by the edge detection section 432, a method of performing edge detection by detecting a pixel region where a luminance level (gray scale) difference between a pixel and its neighboring pixel is larger than a predetermined threshold value in each sub-frame period, or the like is cited. Detection operation by such a conversion region detection section 43 will be described in detail later.

The gray-scale conversion section 44 selectively performs adaptive gray-scale conversion which will be described later on a picture signal (a luminance signal) in a pixel region where the motion information MD and the edge information ED larger than a predetermined threshold value are detected from the inputted picture signal D21 for the sub-pixel SP1 in response to the detection synthesization result signal DCT supplied from the conversion region detection section 43, and includes two adaptive gray-scale conversion sections 441 and 442 and the selection output section 443. Specifically, for example, as illustrated in FIG. 3, the adaptive gray-scale conversion sections 441 and 442 perform gray-scale conversion from the luminance γ characteristic γ1 of the picture signal D21 into a luminance γ characteristic γ1H having higher luminance than original luminance and a luminance γ characteristic γ1L having lower luminance than the original luminance, respectively, and the selection output section 443 alternately selects and outputs picture signals (luminance signals) D31H and D31L corresponding to the two luminance γ characteristics γ1H and γ1L, respectively, in each sub-frame period, thereby the picture signal Dout1 is generated and outputted.

The gray-scale conversion section 45 selectively performs adaptive gray-scale conversion which will be described later on a picture signal (a luminance signal) in a pixel region where the motion information MD and the edge information ED larger than a predetermined threshold value are detected from the inputted picture signal D22 for the sub-pixel SP2 in response to the detection synthesization result signal DCT supplied from the conversion region detection section 43, and includes two adaptive gray-scale conversion sections 451 and 452 and the selection output section 453. Specifically, for example, as illustrated in FIG. 4, the adaptive gray-scale conversion sections 451 and 452 perform gray-scale conversion from the luminance γ characteristic γ2 of the picture signal D22 into a luminance γ characteristic γ2H having higher luminance than original luminance and a luminance γ characteristic γ2L having lower luminance than the original luminance, respectively, and the selection output section 453 alternately selects and outputs picture signals (luminance signals) D32H and D32L corresponding to the two luminance γ characteristics γ2H and γ2L, respectively, in each sub-frame period, thereby the picture signal Dout2 is generated and outputted.

The picture memory 62 is a frame memory storing the picture signals Dout1 and Dout2 for each pixel 20 on which adaptive gray-scale conversion is performed by the image processing section 4 in each sub-frame period. The timing control section (timing generator) 61 controls the drive timings of the X driver 51, the Y driver 52 and the backlight drive section 63 on the basis of the picture signals Dout1 and Dout2. The X driver (data driver) 51 supplies a drive voltage corresponding to the picture signals Dout1 and Dout2 to the sub-pixels SP1 and SP2 in each pixel 20 of the liquid crystal display panel 2. The Y driver (gate driver) 52 line-sequentially drives each pixel 20 in the liquid crystal display panel 2 along a scanning line (not illustrated) according to timing control by the timing control section 61. The backlight drive section 63 controls the lighting operation of the backlight section 3 according to timing control by the timing control section 61.

Here, the liquid crystal display panel 2 and the backlight section 3 correspond to specific examples of “a display means” in the invention, and the two sub-pixels SP1 and SP2 correspond to specific examples of “a plurality of sub-pixels” in the invention. Moreover, the frame rate conversion section 41 corresponds to a specific example of “a frame division means” in the invention, and the conversion region detection section 43 corresponds to a specific example of “a detection section” in the invention. Further, the sub-pixel drive conversion section 42 and the gray-scale conversion sections 44 and 45 correspond to specific examples of “a gray-scale conversion means” in the invention.

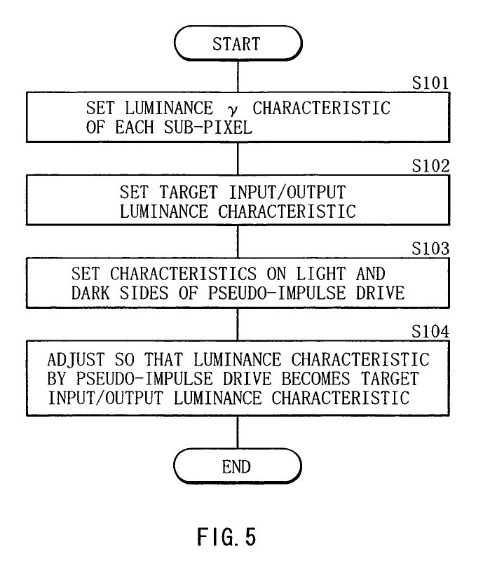

Next, referring to FIG. 5, a method of setting and adjusting a luminance γ characteristic (a lookup table) in each of the sub-pixels SP1 and SP2 illustrated in FIGS. 2 to 4 will be described in detail below. In addition, such setting and adjustment of the luminance γ characteristic is performed before performing image processing by the image processing section 4.

First, the setting of the luminance γ characteristics γ1 and γ2 in the sub-pixels SP1 and SP2 for performing gray-scale conversion (division) into two sub-pixels SP1 and SP2 by the sub-pixel drive conversion section 42 is performed (step S101). Specifically, an effect of improving motion picture response by pseudo-impulse drive or an effect of improving a viewing angle by a sub-pixel configuration is selected as a higher priority according to such luminance γ characteristics, thereby characteristic curves of the luminance γ characteristics γ1 and γ2 corresponding to two sub-pixels SP1 and SP2 illustrated in FIG. 2 are set. More specifically, to improve the viewing angle characteristic (in an intermediate luminance level) in the image display 1, the gray-scale conversion characteristics γ1 and γ2 in the sub-pixels SP1 and SP2 are established so that a difference in display luminance between the sub-pixels SP1 and SP2 in each pixel 20 becomes as large as possible (becomes larger than a predetermined threshold value). In addition, the luminance characteristics γ1 and γ2 are set in consideration of the areas, shapes, orientation characteristics or the like of the sub-pixels SP1 and SP2.

Next, as in the case of the luminance γ characteristic γ0 in FIG. 2, an input/output luminance γ characteristic as a target for the luminance γ characteristics γ1 and dγ2 is set (step S102). In this case, the input/output luminance γ characteristic as the target is the luminance γ characteristic γ0 of the original picture signal D1 subjected to frame rate conversion. Specifically, the luminance γ characteristics γ1 and γ2 of the sub-pixels SP1 and SP2 are established so that the space integral values of display luminance of the sub-pixels SP 1 and SP2 in each pixel 20 are substantially equal to luminance represented by the picture signal D1 (the luminance γ characteristic γ0) in the pixel.

Next, the luminance γ characteristics γ1H, γ1L, γ2H and γ2L, that is, characteristics on light and dark sides of improved pseudo-impulse drive are set by performing simulation in consideration of the transmittance of a liquid crystal (step S103). In addition, the transmittance of the liquid crystal in each pixel 20 is calculated through the use of the total value of transmittance in the sub-pixels SP1 and SP2.

Finally, the characteristic curves of the luminance γ characteristics γ1H, γ1L, γ2H and γ2L are finely adjusted so that a luminance characteristic (a display luminance characteristic) by improved pseudo-impulse drive on the basis of the luminance γ characteristics γ1H, γ1L, γ2H and γ2L which are set in the step S103 becomes the input/output luminance characteristic (the luminance γ characteristic γ0) which is set as the target in the step S102 (step S104). In other words, adjustment is performed so that a luminance characteristic by normal drive on the basis of the original luminance characteristic γ0 and a luminance characteristic by improved pseudo-impulse drive on the basis of the luminance γ characteristics γ1H, γ1L, γ2H and γ2L are substantially equal to each other. Thus, setting and adjustment of the luminance γ characteristic (the lookup table) in each of the sub-pixels SP1 and SP2 are completed.

Next, operations of the image processing section 4 having such a configuration and the whole liquid crystal display 1 according to the embodiment will be described in detail below.

In the whole liquid crystal display 1 of the embodiment, as illustrated in FIG. 1, image processing is performed on the picture signal Din supplied from outside by the image processing section 4, thereby two picture signals Dout1 and Dout2 for the sub-pixels SP1 and SP2 are generated. Then, illumination light from the backlight section 3 is modulated by the liquid crystal display panel 2 by a drive voltage (a pixel application voltage) outputted from the X driver 51 and the Y driver 52 to the sub-pixels SP1 and SP2 in each pixel 20 on the basis of the picture signals Dout1 and Dout2 to be outputted from the liquid crystal display panel 2 as display light. Thus, image display is performed by the display light corresponding to the picture signal Din.

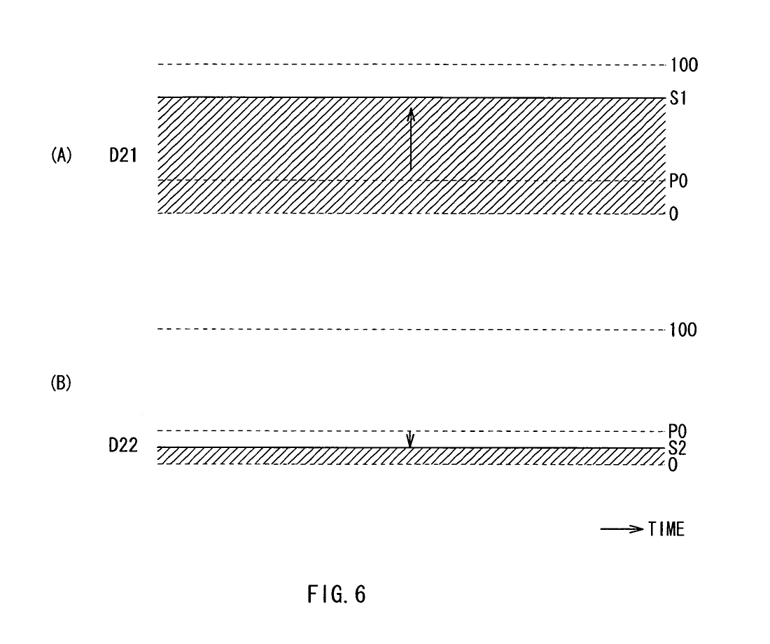

Now, referring to FIGS. 6 to 9 in addition to FIGS. 1 to 4, image processing operation by the image processing section 4 as one of characteristic points of the invention will be described in detail below.

In the image processing section 4 of the embodiment, the frame rate (for example, 60 Hz) of the picture signal Din is converted into a higher frame rate (for example 120 Hz) by the frame rate coversion section 41. Specifically, the unit frame period (for example, ( 1/60) seconds) of the picture signal Din is divided into two sub-frame periods (for example, ( 1/120) seconds), thereby a picture signal D1 consisting of, for example, two sub-frame periods SF1 and SF2 is generated.

Next, in the sub-pixel drive conversion section 42, gray-scale conversion is performed on the picture signal D1 supplied from the frame rate conversion section 41 to generate the picture signals D21 and D22 for two sub-pixels SP1 and SP2, respectively, while maintaining the space integral value of display luminance. In other words, for example, as illustrated in FIG. 2, gray-scale conversion is performed so that the luminance γ characteristic γ0 is divided into the luminance γ characteristics γ1 for the sub-pixel SP1 (for the picture signal D21) and the luminance γ characteristic γ2 for the sub-pixel SP2 (for the picture signal D22). Therefore, for example, in the case where an input gray scale (the gradation level of the picture signal D1) is 50 IRE, as illustrated in FIGS. 2 and 6, output gray scales (luminance levels of the picture signals D21 and D22) are s1 and s2, respectively, and compared to luminance by the original picture signal D1 (the luminance γ characteristic γ0), the output gray scales are shifted to a higher luminance side or a lower luminance side.

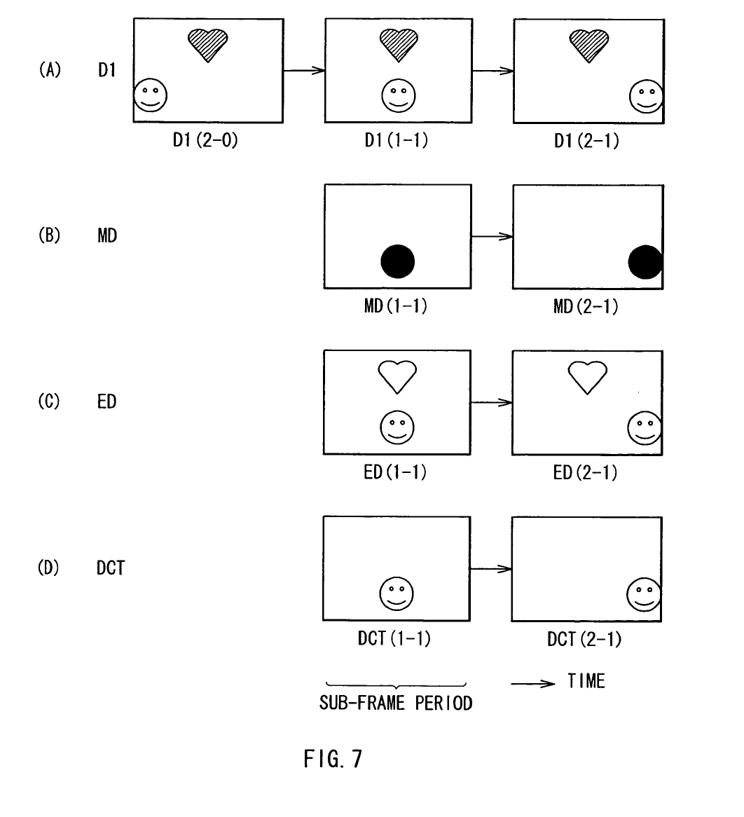

On the other hand, in the conversion region detection section 43, for example, as illustrated in FIG. 7, the motion information MD and the edge information ED are detected, and a conversion region is detected on the basis of the information. Specifically, when, for example, the picture signal D1 (picture signals D1(2-0), D1(1-1) and D1(2-1)) as illustrated in FIG. 7(A) as a base of a displayed picture is inputted, for example, motion information MD (motion information MD(1-1) and MD(2-1)) as illustrated in FIG. 7(B) is detected by the motion detection section 431, and, for example, edge information ED (edge information ED(1-1) and ED(1-2)) as illustrated in FIG. 7(C) is detected by the edge detection section 432. Then, for example, the detection synthesization result signals DCT (detection synthesization result signals DCT(1-1) and DCT(2-1)) as illustrated in FIG. 7(D) are generated by the detection synthesization section 433 on the basis of the motion information MD and the edge information ED detected in such a manner, thereby a region (a conversion region) to be subjected to gray-scale conversion by the gray-scale conversion sections 44 and 45, that is, an edge region in a motion picture which causes a decline in motion picture response is specified.

Next, in the gray-scale conversion sections 44 and 45, on the basis of the picture signals D21 and D22 for the sub-pixels SP1 and SP2 supplied from the sub-pixel drive conversion section 42 and the detection result synthesization signals DCT supplied from the conversion region detection section 43, adaptive gray-scale conversion (gray-scale conversion corresponding to improved pseudo-impulse drive) using the luminance γ characteristics γ1H, γ1L, γ2H and γ2L illustrated in FIGS. 3 and 4 is performed on a picture signal in a pixel region (a detection region; specifically, for example, an edge region in a motion picture) in which the motion information MD and the edge information ED larger than a predetermined threshold value are detected from the picture signals D21 and D22, and on the other hand, adaptive gray-scale conversion is not performed on a picture signal in a pixel region (a pixel region other than the detection region) in which motion information MD and edge information ED smaller than the predetermined threshold value are detected from the picture signals D21 and D22, and the picture signals D21 and D22 using the luminance γ characteristics γ1 and γ2 are outputted as they are. In other words, adaptive gray-scale conversion is selectively performed on a picture signal in a pixel region where the motion information MD and the edge information ED larger than the predetermined threshold value are detected from the picture signals D21 and D22 to perform pseudo-impulse drive.

Specifically, in the gray-scale conversion section 44, for example, as illustrated in FIG. 3, the adaptive gray-scale conversion section 441 performs adaptive gray-scale conversion on the picture signal D21 on the basis of the luminance γ characteristic γ1H to generate the picture signal D31H, and the adaptive gray-scale conversion section 442 performs adaptive gray-scale conversion on the picture D21 on the basis of the luminance γ characteristic γ1L to generate the picture signal D31L, and the selection output section 443 alternately selects and outputs these two picture signals D31H and D31L in each sub-frame period, thereby the picture signal Dout1 is generated and outputted. Moreover, in the same manner, in the gray-scale conversion section 45, for example, as illustrated in FIG. 4, the adaptive gray-scale conversion section 451 performs adaptive gray-scale conversion on the picture signal D22 on the basis of the luminance γ characteristic γ2H to generate the picture signal D32H, and the adaptive gray-scale conversion section 452 performs adaptive gray-scale conversion on the picture signal D22 on the basis of the luminance γ characteristic γ2L to generate the picture signal D32L, and the selection output section 453 alternately selects and outputs these two picture signals D32H and D32L in each sub-frame period, thereby the picture signal Dout2 is generated and outputted.

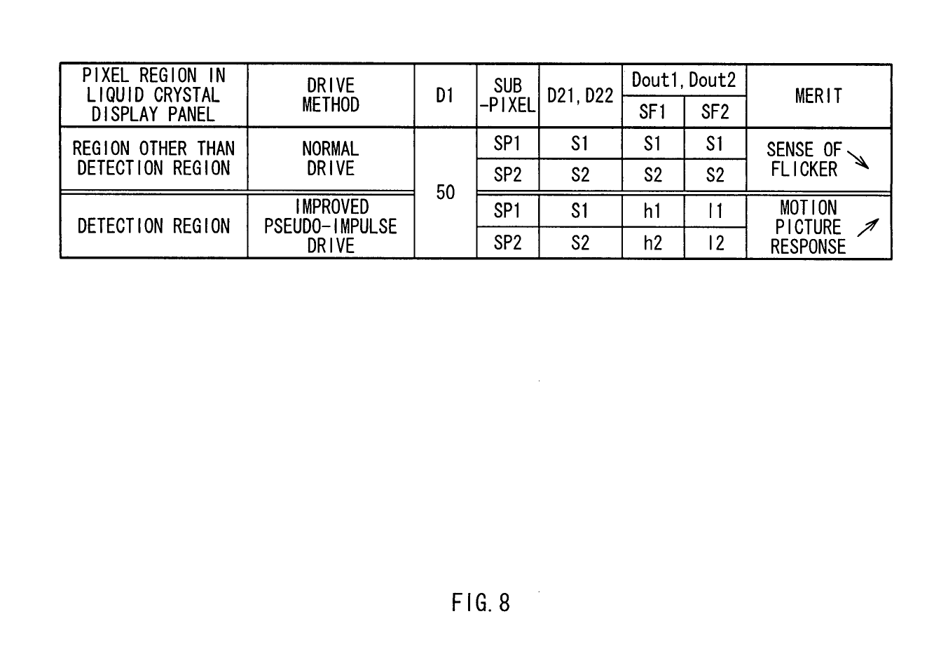

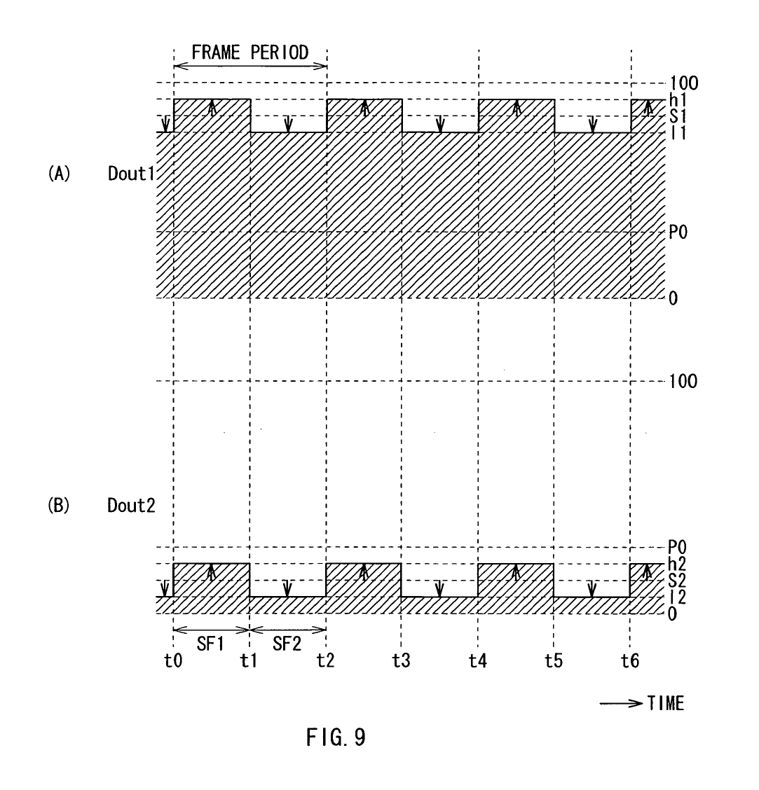

More specifically, for example, as illustrated in FIG. 8, in a pixel region other than the detection region, normal drive (a drive method other than improved pseudo-impulse drive) is performed by the X driver 51 and the Y driver 52; therefore, for example, in the case where the gray scale (the luminance level) of the picture signal D1 is 50 IRE, by the adaptive gray-scale conversion sections 44 and 45, adaptive gray-scale conversion is not performed on the picture signals D21 and D22 (of which the luminance levels are s1 and s2, respectively) for the sub-pixels SP1 and SP2 outputted from the sub-pixel drive conversion section 42, and the picture signals D21 and D22 are outputted as the picture signals Dout1 and Dout2 while the sub-frame periods SF1 and SF2 still have the luminance levels s1 and s2, respectively. On the other hand, in the detection region, improved pseudo-impulse drive is performed by the X driver 51 and the Y driver 52; therefore, for example, in the case where the gray scale (the luminance level) of the picture signal D1 is 50 IRE, by the adaptive gray-scale conversion sections 44 and 45, adaptive gray-scale conversion is performed on the picture signals D21 and D22 (of which the luminance level are s1 and s2, respectively) for the sub-pixels SP1 and SP2 outputted from the sub-pixel drive conversion section 42, thereby in the picture signal Dout1 for the sub-pixel SP1, the luminance levels of the sub-frame period SF1 and the sub-frame period SF2 are changed to be h1 and 11, respectively, and on the other hand, in the picture signal Dout 2 for the sub-pixel SP2, the luminance levels of the sub-frame period SF1 and the sub-frame period SF2 are changed to be h2 and 12, respectively. Therefore, in the detection region, for example, as illustrated in FIGS. 9(A) and (B) (timings t0 to t6), adaptive gray-scale conversion is selectively performed on the picture signals Dout1 and Dout2 obtained by gray-scale conversion so that, while allowing the time integral value of luminance within the unit frame period to be maintained as it is, a high luminance period (the sub-frame period SF1) having luminance levels h1 and h2 higher than the luminance level s1 and s2 of the original picture signals D21 and D22 and a low luminance period (the sub-frame period SF2) having luminance levels lower than the luminance levels 11 and 12 of the original picture signal D21 and D22 are allocated to the sub-frame periods in the unit frame period, respectively.

In addition, the picture signals Dout1 and Dout2 obtained by gray-scale conversion in such a manner are supplied to the picture memory 62 and the timing control section 61, and a picture on the basis of the picture signals Dout1 and Dout2 is displayed on the liquid crystal display panel 2.

Thus, in the image processing section 4 of the embodiment, the unit frame period of the input picture signal Din is divided into a plurality of sub-frame periods SF1 and SF2, thereby the picture signal D1 is generated by frame rate conversion, and the motion information MD and the edge information ED of the picture signal D1 are detected in each pixel 20. Then, adaptive gray-scale conversion is selectively performed on a picture signal in a pixel region (the detection region) in which motion information MD and edge information ED larger than the predetermined threshold value are detected from the picture signals D21 and D22 corresponding to the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively. Thus, adaptive gray-scale conversion is selectively performed on a picture signal in a pixel region (the detection region) in which the motion information MD and the edge information ED are larger than the predetermined threshold value, so as illustrated in FIG. 8, while motion picture response is improved by pseudo-impulse drive in the detection region, a sense of flicker is reduced by normal drive in a pixel region other than the detection region. Therefore, compared to the case where adaptive gray-scale conversion is performed on picture signals in all pixel regions as in the case of related art, while high motion picture response is maintained, the sense of flicker is reduced. Moreover, adaptive gray-scale conversion is performed in each of the sub-pixels SP1 and SP2 so that the sub-pixels SP1 and SP2 in each pixel 20 have different display luminance from each other, so adaptive gray-scale conversion suitable for different display luminance of the sub-pixels SP1 and SP2 is possible.

As described above, in the embodiment, the unit frame period of the input picture signal Din is divided into a plurality of sub-frame periods SF1 and SF2 to generate the picture signal D1 by frame rate conversion, and the motion information MD and the edge information ED of the picture signal D1 are detected in each pixel 20, and adaptive gray-scale conversion is selectively performed on a picture signal in a pixel region (the detection region) in which the motion information MD and the edge information ED larger than the predetermined threshold value are detected from the picture signals D21 and D22 corresponding to the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively, so motion picture response is able to be improved by pseudo-impulse drive, and compared to the case where adaptive gray-scale conversion is performed on luminance signals in all pixel regions as in the case of related art, the sense of flicker is able to be reduced. Moreover, adaptive gray-scale conversion is performed on each of the sub-pixels SP1 and SP2 so that the sub-pixels SP1 and SP2 in each pixel 20 have different display luminance from each other, so adaptive gray-scale conversion suitable for different display luminance of the sub-pixels SP1 and SP2 is possible, and the viewing angle characteristic is also able to be improved. Therefore, in the image display having the sub-pixel configuration, while reducing the sense of flicker, compatibility between extension of the viewing angle characteristic and an improvement in motion picture response is able to be achieved.

Specifically, the picture signal D1 for each pixel is converted into the picture signals D21 and D22 for the sub-pixels SP1 and SP2 by the sub-pixel drive conversion section 42 while maintaining the space integral value of luminance, and adaptive gray-scale conversion is performed on the picture signals D21 and D22 by the gray-scale conversion sections 44 and 45, so the above-described functions and effects are able to be obtained.

Moreover, the luminance γ characteristics γ1 and γ2 of the sub-pixels SP1 and SP2 are established so that the space integral values of display luminance of the sub-pixels SP1 and SP2 in each pixel 20 are substantially equal to luminance (the luminance γ characteristic γ0) represented by the picture signal D1 in the pixel, so the above-described effects are able to be obtained while display luminance of the original picture signal D1 is substantially equal to display luminance of the picture signals Dout1 and Dout2 obtained by the adaptive gray-scale conversion.

Further, display luminance in the sub-pixels SP1 and SP2 of each pixel 20 is set to be predetermined gray-scale conversion characteristics γ1 and γ2, so as display luminance in the sub-pixels SP1 and SP2 approaches ideal SPVA drive, the viewing angle characteristic (in an intermediate luminance level) in the image display 1 is able to be further improved.

### Second Embodiment

Next, a second embodiment of the invention will be described below. By the way, like components are denoted by like numerals as of the first embodiment and will not be further described. Moreover, an image processing method according to the embodiment is embodied by an image processing apparatus according to the embodiment, and will be also described below.

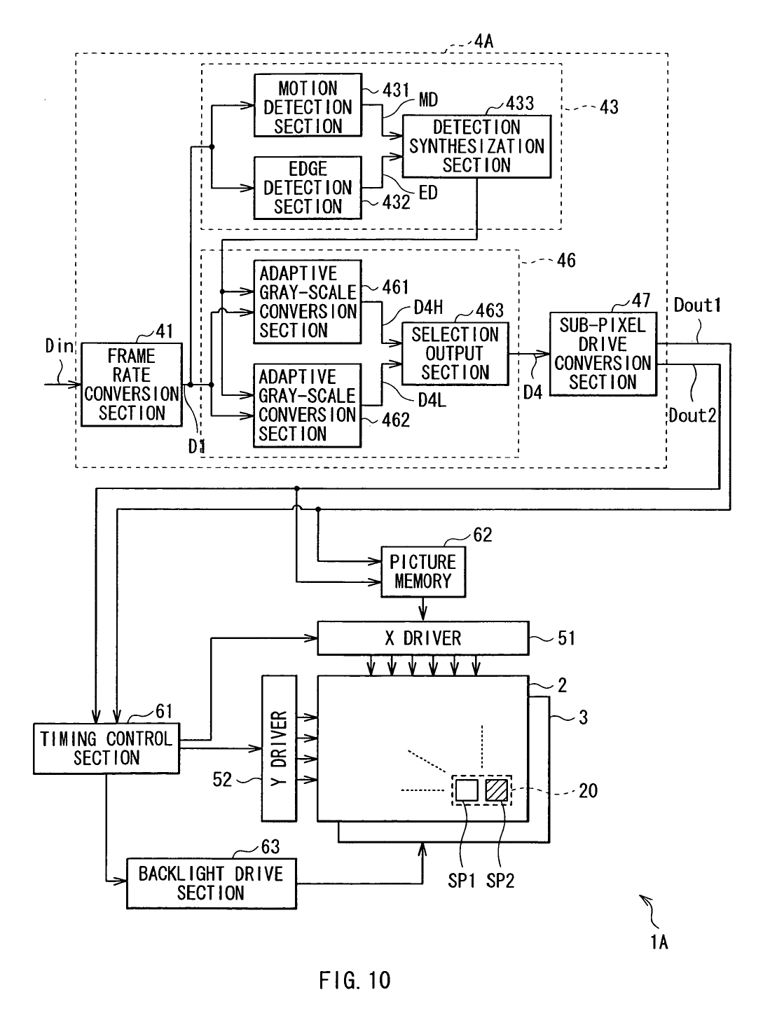

FIG. 10 illustrates the whole configuration of an image display (a liquid crystal display 1A) including the image processing apparatus (an image processing section 4A) according to the embodiment. The image display 1A is distinguished from the image display 1 of the first embodiment illustrated in FIG. 1 by the fact that the image processing section 4A is arranged instead of the image processing section 4.

The image processing section 4A includes one gray-scale conversion section 46 instead of two gray-scale conversion sections 44 and 45 in the image processing section 4, and a sub-pixel drive conversion section 47 instead of the sub-pixel drive conversion section 42, and a positional relationship between the gray-scale conversion section and the sub-pixel drive conversion section are opposite to that in the first embodiment. Specifically, in the image processing section 4 of the first embodiment, the sub-pixel conversion section 42 is arranged between the frame rate conversion section 41 and the gray-scale conversion sections 44 and 45, but in the image processing section 4A of the embodiment, the gray-scale conversion section 46 is arranged between the frame rate conversion section 41 and the sub-pixel conversion section 47.

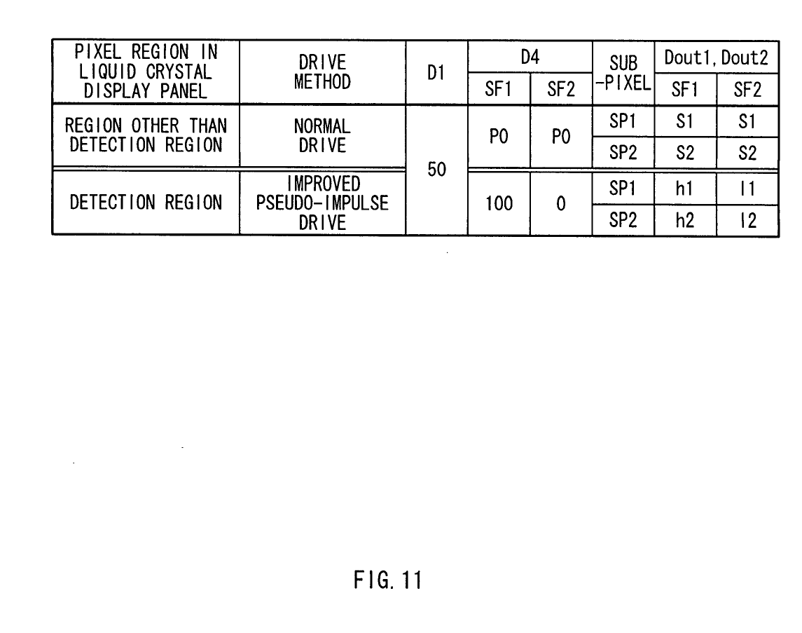

The gray-scale conversion section 46 selectively performs, for example, adaptive gray-scale conversion as illustrated in FIG. 11 on a picture signal in a pixel region (a detection region) in which motion information MD and edge information ED larger than a predetermined threshold value are detected from the inputted picture signal D1 in response to the detection synthesization result signal DCT supplied from the conversion region detection section 43, and includes adaptive gray-scale conversion sections 461 and 462 generating picture signals D4H and D4L, respectively, and a selection output section 463 selecting one of the picture signals D4H and D4L in each sub-frame period to output the selected signal as a picture signal D4. Moreover, the sub-pixel drive conversion section 47 performs gray-scale conversion on the picture signal D4 supplied from the gray-scale conversion section 46 to generate and output, for example, picture signals Dout1 and Dout2 for two sub-pixels SP1 and SP2 as illustrated in FIG. 11 while maintaining the space integral value of display luminance.

Therefore, it is obvious from a comparison between FIG. 8 and FIG. 11 that also in the image processing section 4A of the embodiment, the picture signals Dout1 and Dout2 for the sub-pixels SP1 and SP2 which are the same as those in the image processing section 4 of the first embodiment are generated and outputted in the end. Therefore, the same effects are able to be obtained by the same functions as those in the first embodiment. In other words, in the image display having the sub-pixel configuration, while the sense of flicker is reduced, compatibility between extension of the viewing angle characteristic and an improvement in motion picture response is able to be achieved.

Moreover, in the image processing section 4A of the embodiment, contrary to the first embodiment, adaptive gray-scale conversion is performed on the picture signal D1 for each pixel by the gray-scale conversion 46, and while maintaining the space integral value, the picture signal D4 for each pixel obtained by the conversion is converted into picture signals Dout1 and Dout2 for the sub-pixels SP1 and SP2, so compared to the image processing section 4 of the first embodiment in which adaptive gray-scale conversion is performed in each of the sub-pixels SP1 and SP2 after converting the picture signal D1 into the picture signals D21 and D22 for the sub-pixels SP1 and SP2, the apparatus configuration is able to be simplified. Therefore, in addition to the effects in the first embodiment, a reduction in the apparatus configuration (a reduction in the profile of the apparatus configuration) or a reduction in manufacturing costs may be achieved.

Although the present invention is described referring to the first and second embodiments, the invention is not limited thereto, and may be variously modified.

For example, in the above-described first and second embodiments, the case where adaptive gray-scale conversion is selectively performed on a pixel region where both of the motion information MD and the edge information ED are larger than the predetermined threshold value as a conversion processing region (the detection region) is described; however, more typically, adaptive gray-scale conversion may be performed on a pixel region where one or both of the motion information MD and the edge information ED is larger than the predetermined threshold value as the conversion processing region (the detection region).

Moreover, in the above-described first and second embodiments, the case where adaptive gray-scale conversion processing by the gray-scale conversion section is selectively performed in response to a detection result (the detection synthesization result signal DCT) by the conversion region detection section 43 is described; however, in some cases, sub-pixel drive conversion processing by the sub-pixel drive conversion section 42 may be also selectively performed in response to the detection result (the detection synthesization result signal DCT) by the conversion region detection section 43.

Further, in the above-described first and second embodiments, the case where one unit frame period includes two sub-frame periods SF1 and SF2 is described; however, the frame rate conversion section 41 may perform frame rate conversion so that one unit frame period includes three or more sub-frame periods.

Moreover, in the above-described first and second embodiments, the case where each pixel 20 includes two sub-pixels SP1 and SP2 is described; however, each pixel 20 may include three or more sub-pixels.

Further, in the above-described first and second embodiments, the liquid crystal display 1 including the liquid crystal display panel 2 and the backlight section 3 as an example of the image display is described; however, the image processing apparatus of the invention is applicable to any other image display, that is, for example, a plasma display (PDP: Plasma Display Panel) or an EL (ElectroLuminescence) display.

### Third Embodiment

Next, a third embodiment of the invention will be described below.

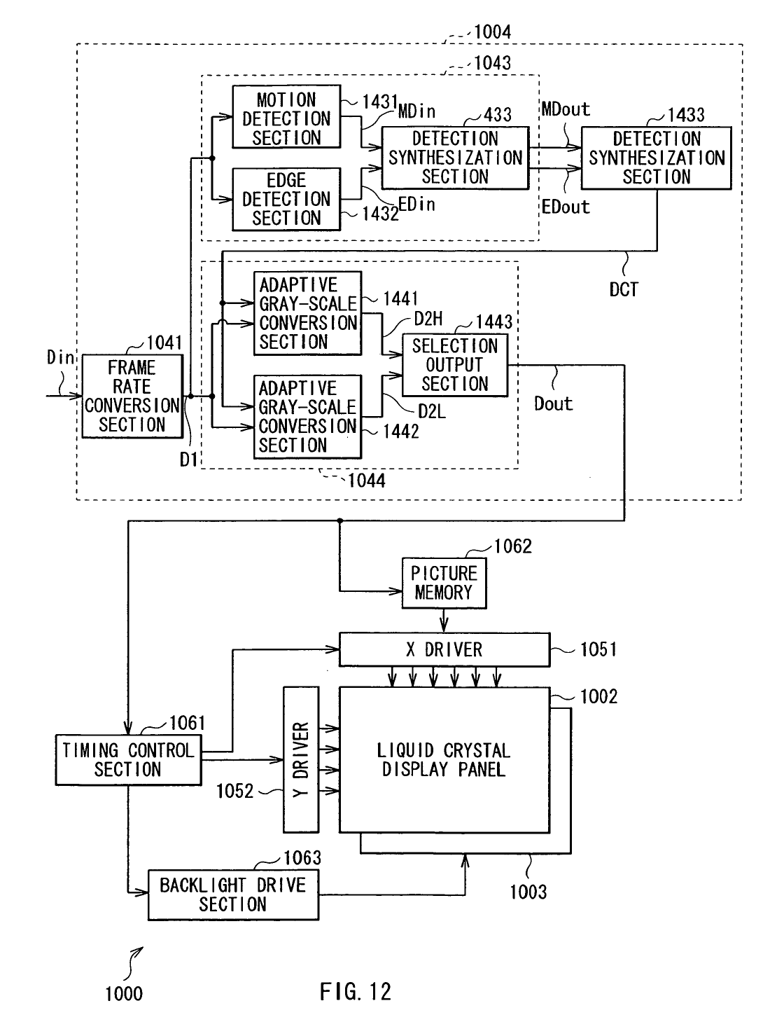

FIG. 12 illustrates the whole configuration of an image display (a liquid crystal display 1001) including an image processing apparatus (an image processing section 2004) according to the third embodiment of the invention. The liquid crystal display 1001 includes a liquid crystal display panel 1002, a backlight section 1003, the image processing section 1004, a picture memory 1062, an X driver 1051, a Y driver 1052, a timing control section 1061 and a backlight control section 1063. In addition, an image processing method according to the embodiment is embodied by the image processing apparatus according to the embodiment, and will be also described below.

The liquid crystal display panel 1002 displays a picture corresponding to, for example, a picture signal Din by a drive signal supplied from the X driver 1051 and the Y driver 1052 which will be described later, and includes a plurality of pixels (not illustrated) arranged in a matrix form.

The backlight section 3 is a light source applying light to the liquid crystal display panel 1002, and includes, for example, a CCFL (Cold Cathode Fluorescent Lamp), an LED (Light Emitting Diode) or the like.

The image processing section 1004 performs predetermined image processing which will be described later on the picture signal Din (a luminance signal) from outside to generate a picture signal Dout, and includes a frame rate conversion section 1041, a conversion region detection section 1043 and a gray-scale conversion section 1044.

The frame rate conversion section 1041 converts the frame rate (for example, 60 Hz) of the picture signal Din into a higher frame rate (for example, 120 Hz). Specifically, the unit frame period (for example, ( 1/60) seconds) of the picture signal Din is divided into a plurality of (for example, two) sub-frame periods (for example, ( 1/120) seconds) to generate a picture signal D1 (a luminance signal) consisting, for example, two sub-frame periods. In addition, as a method of generating the picture signal D1 by such frame rate conversion, for example, a method of producing an interpolation frame by motion detection or a method of producing an interpolation frame by simply duplicating the original video signal Din is considered.

The conversion region detection section 1043 detects motion information (a motion index) MDin and edge information (an edge index) EDin for each pixel in each sub-frame period from the picture signal D1 supplied from the frame rate conversion section 1041, and includes a motion detection section 1431, an edge information detection section 1432, a discontinuity detection/correction section 1434 and a detection synthesization section 1433.

The motion detection section 1431 detects the motion information MDin for each pixel in each sub-frame period from the picture signal D1, and the edge detection section 1432 detects the edge information EDin for each pixel in each sub-frame period from the picture signal D1. The discontinuity detection/correction section 1434 detects (determines) the presence or absence of discontinuity for each pixel along a time axis in the motion information MDin detected by the motion detection section 1431 and the edge information EDin detected by the edge detection section 1432, and in the case where discontinuity is present in the motion information MDin or the edge information EDin, the discontinuity detection/correction section 1434 corrects the motion information MDin and the edge information EDin for each pixel so as to eliminate the discontinuity, and outputs motion information MDout and edge information EDout. The detection synthesization section 1433 combines the motion information MDout and the edge information EDout supplied from the discontinuity detection/correction section 1434, and generates and outputs a detection synthesization result signal DCT by performing various adjustment processes (a detection region expanding process, a detection region rounding process, an isolated point detection process or the like). The configuration of the discontinuity detection/correction section 1434 and detection operation by the conversion region detection section 43 will be described in detail later.

In addition, as a motion detection method by the motion detection section 1431, for example, a method of detecting a motion vector through the use of a block matching method, a method of detecting a motion vector between sub-frames through the use of a difference signal between sub-frames, or the like is cited. Moreover, as an edge detection method by the edge detection section 1432, a method of performing edge detection by detecting a pixel region where a luminance level (gray scale) difference between a pixel and its neighboring pixel is larger than a predetermined threshold value in each sub-frame period, or the like is cited.

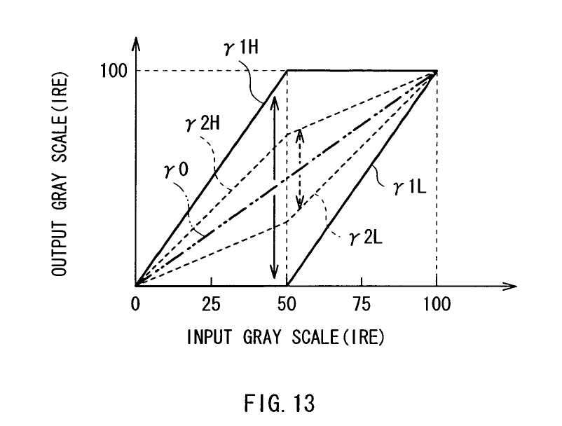

The gray-scale conversion section 1044 selectively performs adaptive gray-scale conversion which will be described later on a picture signal (a luminance signal) in a pixel region where the motion information MDout and the edge information EDout larger than a predetermined threshold value are detected from the inputted picture signal D1 in response to the detection synthesization result signal DCT supplied from the conversion region detection section 1043, and includes two adaptive gray-scale conversion sections 1441 and 1442 and a selection output section 1443. Specifically, for example, as illustrated in FIG. 13, the adaptive gray-scale conversion sections 1441 and 1442 perform gray-scale conversion from an (input/output) gray-scale conversion characteristic (a luminance γ characteristic) y0 of the picture signal D1 to a luminance γ characteristic γ1H having higher luminance than original luminance and a luminance γ characteristic γ1L having lower luminance than the original luminance, respectively, and the selection output section 1443 alternately selects and outputs picture signals (luminance signals) D21H and D21L corresponding to the two luminance γ characteristics γ1H and γ1L, respectively, in each sub-frame period, thereby a picture signal (a luminance signal) Dout is generated and outputted.

In addition, adaptive gray-scale conversion may be performed on the luminance γ characteristic γ0 of the picture signal D1 through the use of, for example, luminance γ characteristics γ2H and γ2L in FIG. 13 instead of the luminance γ characteristics γ1H and γ1L. However, an effect of improving motion picture response is higher in the case where adaptive gray-scale conversion is performed through the use of the luminance γ characteristics γ1H and γ1L than in the case where adaptive gray-scale conversion is performed through the use of the luminance γ characteristics γ2H and γ2L, so the luminance γ characteristics γ1H and γ1L are preferably used. Moreover, in FIG. 13, the luminance γ characteristic γ0 is a linear straight line; however, the luminance γ characteristic γ0 may be, for example, a nonlinear γ2.2 curve, or the like.

The picture memory 1062 is a frame memory storing the picture signal Dout for each pixel on which adaptive gray-scale conversion is performed by the image processing section 1004 in each sub-frame period. The timing control section (a timing generator) 1061 controls the drive timings of the X driver 1051, the Y driver 1052 and the backlight drive section 1063 on the basis of the picture signals Dout. The X driver (data driver) 1051 supplies a drive voltage corresponding to the picture signal Dout to each pixel of the liquid crystal display panel 1002. The Y driver (gate driver) 1052 line-sequentially drives each pixel in the liquid crystal display panel 1002 along a scanning line (not illustrated) according to timing control by the timing control section 1061. The backlight drive section 1063 controls the lighting operation of the backlight section 1003 according to timing control by the timing control section 1061.

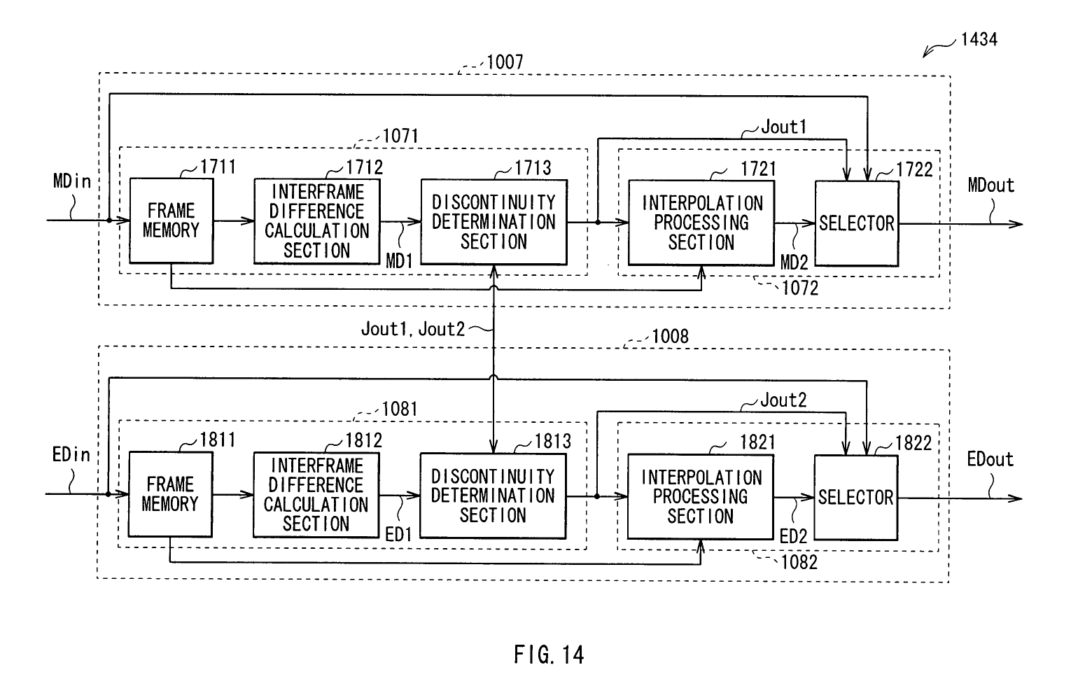

Next, referring to FIG. 14, the configuration of the discontinuity detection/correction section 1434 will be described in detail below. FIG. 14 illustrates a block configuration of the discontinuity detection/correction section 1434.

The discontinuity detection/correction section 1434 includes a discontinuity motion information detection/correction section 1007 and a discontinuity edge information detection/correction section 1008, the motion information detection/correction section 1007 detecting (determining) the presence or absence of discontinuity along a time axis in the motion information MDin detected by the motion detection section 1431, and in the case where the presence of discontinuity in the motion information MDin is determined, correcting the motion information MDin for each pixel to eliminate the discontinuity, and then outputting motion information MDout, the discontinuity edge information detection/correction section 1008 detecting (determining) the presence or absence of discontinuity along a time axis in the edge information EDin detected by the edge detection section 1432, and in the case where the presence of discontinuity in the edge information EDin is determined, correcting the edge information EDin for each pixel so as to eliminate the discontinuity, and then outputting edge information EDout. Moreover, the discontinuity motion information detection/correction section 1007 includes a discontinuity detection section 1071 which detects (determines) the presence or absence of discontinuity along the time axis in the motion information MDin for each pixel, and then outputs a determination signal Jout1, and a discontinuity correction section 1072 which corrects the motion information MDin for each pixel in the case where the presence of discontinuity in the motion information MDin is determined by the determination signal Jout1 so as to eliminate the discontinuity, and then outputs the motion information MDout. Further, the discontinuity edge information detection/correction section 1008 includes a discontinuity detection section 1081 which detects (determines) the presence or absence of discontinuity along the time axis in the edge information EDin for each pixel to output a determination signal Jout2, and a discontinuity correction section 1082 which corrects the edge information EDin for each pixel in the case where the presence of discontinuity in the edge information EDin is determined by the determination signal Jout2 so as to eliminate the discontinuity, and then outputs the edge information EDout.

The discontinuity detection section 1071 includes a frame memory 1711 storing the motion information MDin supplied from the motion detection section 1431 in a plurality of (for example, three) sub-frame periods, an interframe difference calculation section 1712 calculating a difference value MD1 of the motion information MDin between sub-frames for each pixel on the basis of the motion information MDin in the plurality of sub-frame periods stored in the frame memory 1712, and a discontinuity determination section 1713 determining the presence or absence of discontinuity along the time axis of the motion information MDin by comparing the calculated difference value MD1 with a predetermined threshold value (a threshold value Mth which will be described later), and then outputting the determination signal Jout1. Moreover, as in the case of the discontinuity detection section 1071, the discontinuity detection section 1081 includes a frame memory 1811 storing the edge information EDin supplied from the edge detection section 1432 in a plurality of (for example, three) sub-frame periods, an interframe difference calculation section 1812 calculating a difference value ED1 of the edge information EDin between sub-frames for each pixel on the basis of the edge information EDin in the plurality of sub-frame periods stored in the frame memory 1812, and a discontinuity determination section 1813 determining the presence or absence of discontinuity along the time axis of the edge information EDin by comparing the calculated difference value ED1 with a predetermined threshold value (a threshold value Eth which will be described later), and then outputting the determination signal Jout2. In addition, the discontinuity determination section 1713 and the discontinuity determination section 1813 exchange determination information Jout1 and Jout2 with each other, and functions and effects by this will be described later.

The discontinuity correction section 1072 includes an interpolation processing section 1721 and a selector 1722, the interpolation processing section 1721 performing predetermined interpolation processing on the motion information MDin stored in the frame memory 1711 for each pixel in the case where the presence of discontinuity along the time axis in the motion information MDin is determined on the basis of the determination signal Jout1 supplied from the discontinuity determination section 1713, thereby generating motion information MD1 by correcting the motion information MDin so as to eliminate the discontinuity, the selector 1722 selectively outputting one of the original motion information MDin and the motion information MD2 obtained by correction in response to the determination signal Jout1 supplied from the discontinuity determination section 1713. Moreover, as in the case of the discontinuity correction section 1072, the discontinuity correction section 1082 includes an interpolation processing section 1821 and a selector 1822, the interpolation processing section 1821 performing predetermined interpolation processing on the edge information EDin stored in the frame memory 1811 for each pixel in the case where the presence of discontinuity along the time axis in the edge information EDin is determined on the basis of the determination signal Jout 2 supplied from the discontinuity determination section 1813, thereby generating edge information ED1 by correcting the edge information EDin so as to eliminate the discontinuity, the selector 1822 selectively outputting one of the original edge information EDin and the edge information ED2 obtained by correction in response to the determination signal Jout2 supplied from the discontinuity determination section 1813.

In addition, as an interpolation processing method by the interpolation processing sections 1721 and 1821, for example, the following two methods are considered. Between these two methods, a method 2 is preferable, because it is natural for a human's eye (continuity is good) and a burden of interpolation processing is small (processing is easy).

1. A method of calculating, for each pixel, an average value of the motion information MDin or the edge information EDin in sub-frame periods previous to and subsequent to the sub-frame period in which the presence of discontinuity is determined, and outputting the calculated average value as the motion information MD2 or the edge information ED2 obtained by correction.
2. A method of duplicating (copying) the motion information MDin or the edge information EDin in a sub-frame period previous to the sub-frame period in which the presence of discontinuity is determined, and outputting the duplicated motion information MDin or duplicated edge information EDin as the motion information MD2 or the edge information ED2 obtained by correction.

Here, the liquid crystal display panel 1002 and the backlight section 1003 correspond to specific examples of “a display means” in the invention. Moreover, the frame rate conversion section 1041 corresponds to a specific example of “a frame division means” in the invention and the gray-scale conversion section 1044 corresponds to a specific example of “a gray-scale conversion means” in the invention. Further, the motion detection section 1431 and the edge detection section 1432 correspond to specific examples of “a detection section” in the invention, and the discontinuity detection sections 1071 and 1081 correspond to specific examples of “a determination means” in the invention, and the discontinuity correction sections 1072 and 1082 correspond to specific examples of “a correction means” in the invention.

Next, operations of the image processing section 1004 having such a configuration and the whole liquid crystal display 1001 of the embodiment will be described in detail below.

First, referring to FIGS. 12 to 17, basic operations of the image processing section 1004 and the whole liquid crystal display 1001 will be described below.

In the whole liquid crystal display 1001 of the embodiment, as illustrated in FIG. 12, image processing is performed on the picture signal Din supplied from outside by the image processing section 4, thereby the picture signal Dout is generated.

Specifically, first, the frame rate (for example, 60 Hz) of the picture signal Din is converted into a higher frame rate (for example 120 Hz) by the frame rate conversion section 1041. More specifically, the unit frame period (for example, ( 1/60) seconds) of the picture signal Din is divided into two sub-frame periods (for example, ( 1/120) seconds) to generate the picture signal D1 consisting, for example, two sub-frame periods SF1 and SF2.

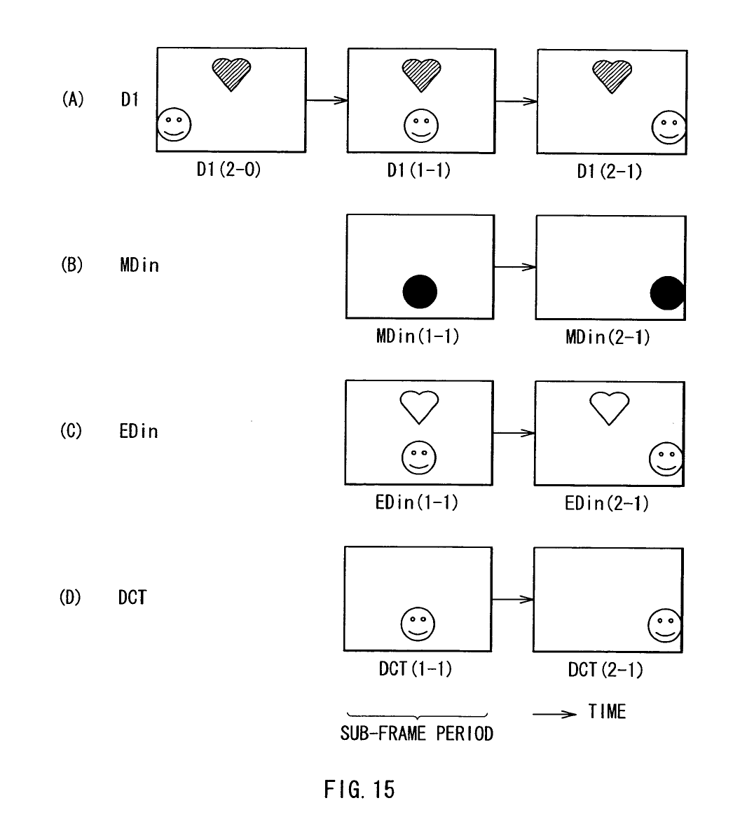

Next, in the conversion region detection section 1043, for example, as illustrated in FIG. 15, the motion information MDin and the edge information EDin are detected, and a conversion region is detected on the basis of the information. Specifically, when, for example, the picture signal D1 (picture signals D1(2-0), D1(1-1) and D1(2-1)) as illustrated in FIG. 15(A) as a base of a displayed picture is inputted, for example, the motion information MDin (motion information MDin(1-1) and MDin(2-1)) as illustrated in FIG. 15(B) is detected by the motion detection section 1431, and, for example, the edge information EDin (edge information EDin(1-1) and EDin(2-1)) as illustrated in FIG. 15(C) is detected by the edge detection section 1432. Then, for example, the detection synthesization result signals DCT (detection synthesization result signals DCT(1-1) and DCT(2-1)) as illustrated in FIG. 15(D) are generated by the detection synthesization section 1433 on the basis of the motion information MDout and the edge information EDout supplied from the discontinuity detection/correction section 1434 based on the motion information MDin and the edge information EDin detected in such a manner. Thereby, a region to be subjected to gray-scale conversion (a conversion region) by the gray-scale conversion section 1044, that is, an edge region in a motion picture which causes a decline in motion picture response is specified.

Next, in the gray-scale conversion section 1044, on the basis of the picture signal D1 supplied from the frame rate conversion section 1041 and the detection result synthesization signal DCT supplied from the conversion region detection section 1043, adaptive gray-scale conversion (gray-scale conversion corresponding to improved pseudo-impulse drive) using the luminance γ characteristics γ1H and γ1L illustrated in FIG. 13 is performed on a picture signal in a pixel region (a detection region; specifically, for example, an edge region in a motion picture) in which the motion information MDout and the edge information EDout larger than a predetermined threshold value are detected from the picture signal D1, and on the other hand, adaptive gray-scale conversion is not performed on a picture signal in a pixel region (a pixel region other than the detection region) in which the motion information MDout and the edge information EDout smaller than the predetermined threshold value are detected from the picture signal D1, and the picture signal D1 using the luminance γ characteristic γ0 is outputted as it is. In other words, adaptive gray-scale conversion is selectively performed on a picture signal in a pixel region where the motion information MDout and the edge information EDout are larger than the predetermined threshold value in the picture signal D1 to perform pseudo-impulse drive.

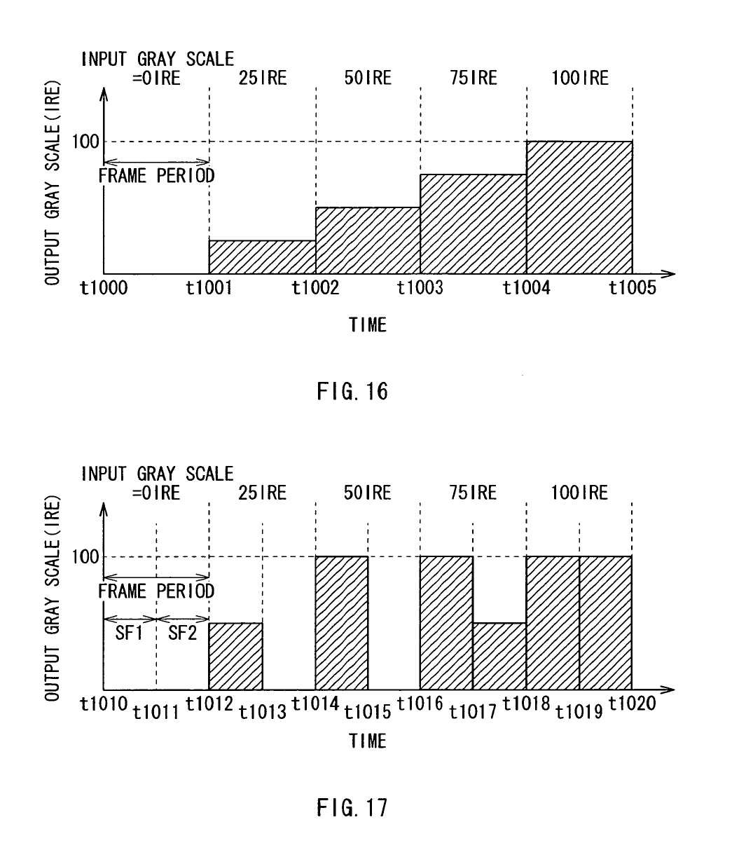

Therefore, in the pixel region (the detection region) on which adaptive gray-scale conversion is performed, in the case where, for example, the luminance gradation level (input gray scale) of the picture signal D1 is temporally changed as illustrated in FIG. 16 (timings t1001 to t1005), for example, as illustrated in FIG. 17 (timings t1010 to t1020), adaptive gray-scale conversion is selectively performed on the luminance gradation level (input gray scale) of the picture signal Dout obtained by adaptive gray-scale conversion so that, while allowing the time integral value of luminance within the unit frame period to be maintained as it is, a high luminance period (the sub-frame period SF1) having a luminance level higher than the luminance level of the original picture signal D1 and a low luminance period (the sub-frame period SF2) having a luminance level lower than the luminance level of the original picture signal D1 are allocated to sub-frame periods in the unit frame period, respectively. In other words, pseudo-impulse drive is performed without sacrificing display luminance, and low motion picture response due to hold-type display is overcome.

Next, illumination light from the backlight section 1003 is modulated by a drive voltage (a pixel application voltage) outputted from the X driver 1051 and the Y driver 1052 to each pixel on the basis of the picture signal (luminance signal) Dout obtained by gray-scale conversion in such a manner to be outputted from the liquid crystal display panel 1002 as display light. Thus, image display is performed by the display light corresponding to the picture signal Din.

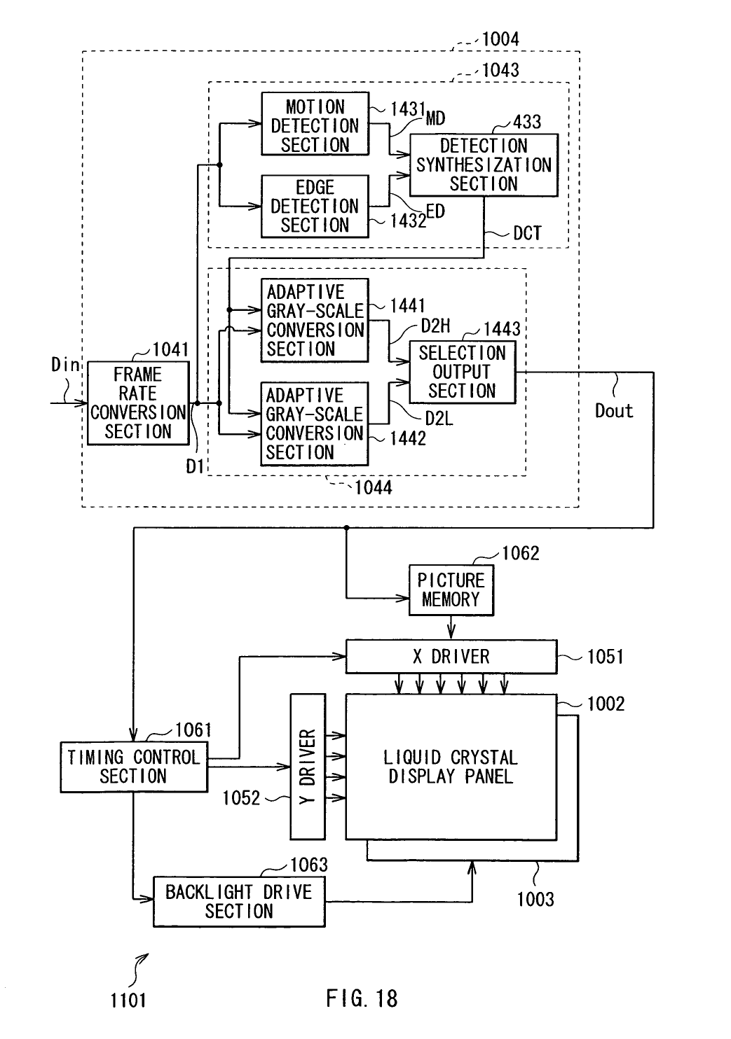

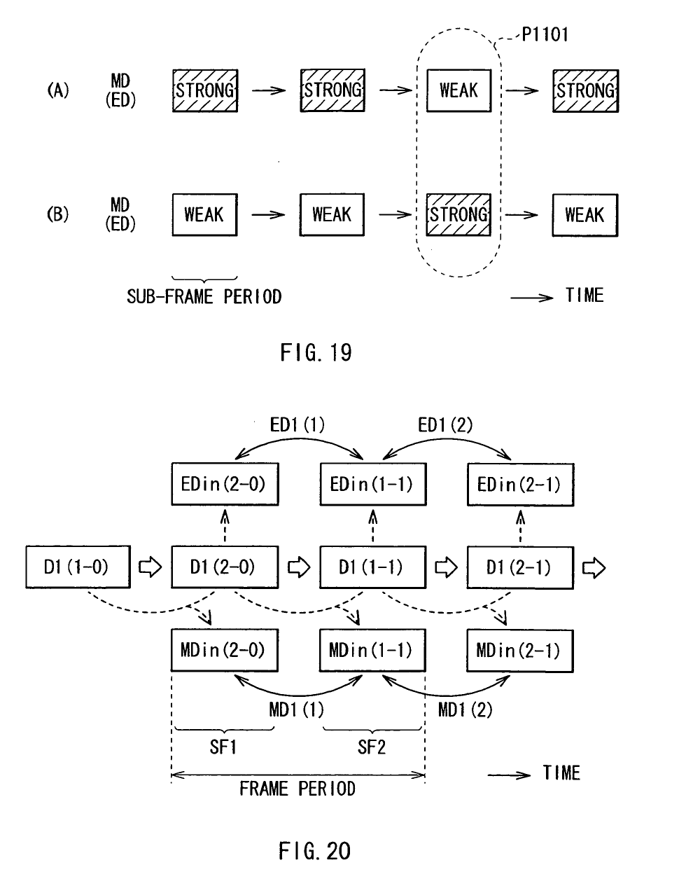

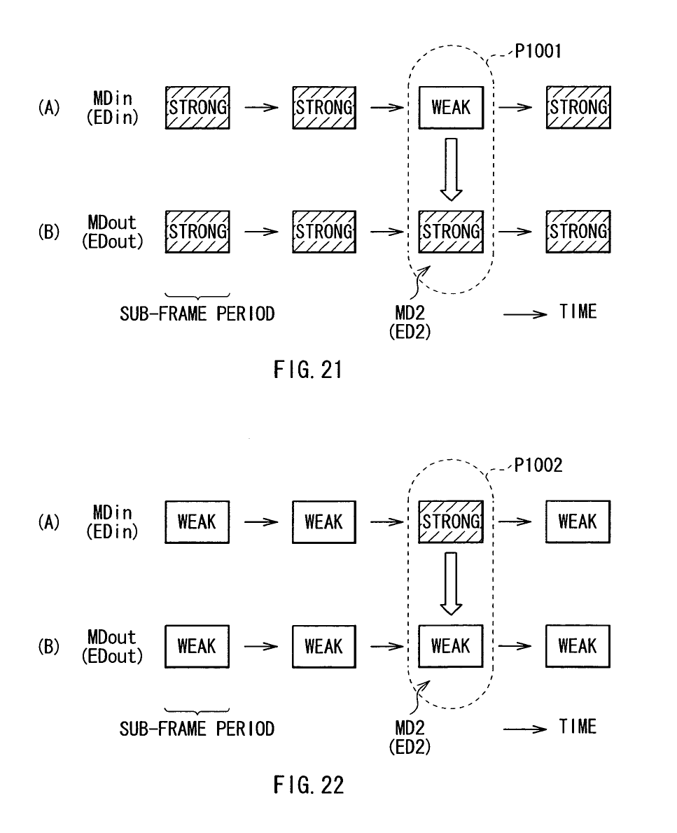

Next, referring to FIGS. 18 to 22 in addition to FIGS. 12 to 17, the operation of the discontinuity detection/correction section 1434 as one of characteristic points of the invention will be described in detail below. Here, FIG. 18 illustrates a block diagram of the whole configuration of an image display (an image display 1101) according to a comparative example, and FIG. 19 illustrates an example of time changes in motion information MD and edge information according to the comparative example. Moreover, FIG. 20 illustrates a timing chart of the operation of the discontinuity detection/correction section 1434 of the embodiment, and FIGS. 21 and 22 are timing charts of an example of an effect of eliminating discontinuity by the discontinuity detection/correction section 1434.

First, in the image display 1101 according to the comparative example, in a conversion region detection section 1143, the motion information MD detected by the motion detection section 1431 and edge information ED detected by the edge detection section 1432 are supplied to the detection synthesization section 1433 as they are, and in the detection synthesization section 1433, the detection synthesization result signal DCT is generated and outputted on the basis of the motion information MD and the edge information ED. Therefore, when irregular motion occurs in a picture to be subjected to processing, or when a too large noise component superimposes on the picture signal Din or the picture signal D1, for example, as illustrated by a reference numeral P1101 in FIGS. 19(A) and (B), discontinuity along a time axis may be generated in the strength of the motion information MD or the edge information ED (“strong” or “weak” in each sub-frame period illustrated in the drawings indicates the strength (magnitude) of the motion information MD or the edge information ED). Then, when such discontinuity is generated, a gray-scale expression balance by a combination of light and dark gray scales in improved pseudo-impulse drive is lost, and as a result, a noise or flicker may occur in a displayed picture to cause degradation in picture quality. Specifically, in improved pseudo-impulse drive, gray-scale expression is performed by, for example, a combination of the luminance characteristics γ1H and γ1L (or a combination of luminance γ characteristics γ2H and γ2L, or the like) in FIG. 13; however, in the case where discontinuity along the time axis is generated in the strength of the motion information MD or the edge information ED as described above, a combination of the luminance γ characteristics γ1H and γ0 or a combination of the luminance γ characteristics γ1L and γ0 may be made momentarily, and in such a case, the luminance may become brighter or darker than original luminance to cause a noise or flicker in a displayed picture.

Therefore, in the image display 1001 of the embodiment, for example, in the case where the picture signal D1 is supplied as illustrated in FIG. 20 (picture signals D1(1-0), D1(2-0), D1(1-1), D1(2-1), . . . ), when the motion information MDin and the edge information EDin as illustrated in the drawing are detected in each sub-frame period by the motion detection section 431 and the edge detection section 1432 (motion information MDin(2-0), MDin(1-1), MDin(2-1), and edge information EDin(2-0), EDin(1-1), EDin(2-1), . . . ), difference values MD1 and ED1 (MD1(1), MD1(2), and ED1(1), ED1(2), . . . ) between the motion information MDin in sub-frames and between the edge information EDin in sub-frames are calculated in each pixel by the interframe difference calculation sections 1712 and 1812 in the discontinuity detection section 1071 and 1081, and on the basis of these difference values MD1 and ED1, discontinuity along the time axis of the motion information MDin or the edge information EDin is determined in each pixel by the discontinuity determination sections 1713 and 1813. Specifically, in the case where the difference values MD1 and ED1 (absolute values of the difference values MD1 and ED1) are equal to or larger than predetermined threshold values Mth and Eth, respectively, the presence of discontinuity is determined, and on the other hand, in the case where the difference values MD1 and ED1 (the absolute values of the difference values MD1 and ED1) are smaller than the threshold values Mth and Eth, respectively, the absence of discontinuity is determined (it is determined that continuity is maintained). In addition, these threshold values Mth and Eth may be manually set in advance, or may be automatically set.

Next, in the interpolation processing sections 1721 and 1821 in the discontinuity correction sections 1072 and 1082, in the case where the presence of discontinuity in the motion information MDin or the edge information EDin is determined on the basis of the determination signals Jout1 and Jout2 from the discontinuity determination sections 1713 and 1813, motion information MD2 or edge information ED2 obtained by being corrected by the above-described predetermined interpolation processing so as to eliminate the discontinuity (so that the difference values ED1 and ED1 (the absolute values of the difference values ED1 and ED1) become smaller than the threshold values Mth and Eth, respectively) are outputted, and on the other hand, in the case where the absence of discontinuity in the motion information MDin or the edge information EDin is determined on the basis of the determination signals Jout1 and Jout2, such interpolation processing is not performed. Then, in the selectors 1722 and 1822, in the case where the presence of discontinuity in the motion information MDin or the edge information EDin is determined on the basis of the determination signals Jout1 and Jout2 from the discontinuity determination sections 1713 and 1813, the motion information MD2 and the edge information ED2 which are obtained by correction are selectively outputted as the motion information MDout and the edge information EDout, and on the other hand, in the case where the absence of discontinuity in the motion information MDin and the edge information EDin is determined on the basis of the determination signals Jout1 and Jout2 from the discontinuity determination sections 1713 and 1813, the original motion information MDin and the original edge information EDin are selectively outputted as they are as the motion information MDout and the edge information EDout.

Therefore, in the image processing section 1004 of the embodiment, even if, for example, the motion information MDin or the edge information EDin having discontinuity along the time axis as illustrated by a reference numeral P1001 in FIG. 21(A) or a reference numeral P1002 in FIG. 22(A) is detected by the motion detection section 1431 or the edge detection section 1432, the motion information MDout or the edge information EDout obtained by eliminating such discontinuity (by being corrected so as to maintain continuity) as illustrated by a reference numeral P1001 in FIG. 21(B) or a reference numeral P1002 in FIG. 22(B) is generated by the discontinuity detection/correction section 1434 to be supplied to the detection synthesization section 1433. Then, in the detection synthesization section 1433, the detection synthesization result signal DCT is generated on the basis of the motion information MDout and the edge information EDout to be supplied to each of the adaptive gray-scale conversion sections 1441 and 1442.

As described above, in the image processing section 1004 of the embodiment, the unit frame period of the input picture signal Din is divided into a plurality of sub-frame periods SF1 and SF2 to generate the picture signal D1 by frame rate conversion, and the motion information and edge information of the picture signal D1 is detected in each pixel. Then, adaptive gray-scale conversion is selectively performed on a picture signal in a pixel region (a detection region) in which the motion information MDout and the edge information EDout larger than the predetermined threshold value are detected from the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively. As adaptive gray-scale conversion is selectively performed on the picture signal in the pixel region (the detection region) in which the motion information MDout and the edge information EDout are larger than the predetermined threshold value in such a manner, while motion picture response is improved by pseudo-impulse drive in the detection region, the sense of flicker is reduced by normal drive in a pixel region other than the detection region. Therefore, compared to the case where adaptive gray-scale conversion is performed on the picture signals in all pixel regions as in the case of related art, while high motion picture response is maintained, the sense of flicker is reduced.

Moreover, in the discontinuity detection/correction section 1434, the presence or absence of discontinuity along the time axis in the detected motion information MDin and the detected edge information EDout is determined in each pixel, and in the case where the presence of discontinuity in the motion information MDin or the edge information EDin is determined, the motion information MDin and the edge information EDin are corrected in each pixel so as to eliminate discontinuity, and are outputted as the motion information MDout and the edge information EDout, so irrespective of contents (the picture signal Din) of a picture or the presence or absence of a noise component, continuity along the time axis in the motion information or the edge information is maintained.

As described above, in the embodiment, the unit frame period of the input picture signal Din is divided into a plurality of sub-frame periods SF1 and SF2 to generate the picture signal D1 by frame rate conversion, and the motion information and edge information of the picture signal D1 are detected in each pixel, and adaptive gray-scale conversion is selectively performed on the picture signal in the pixel region (the detection region) in which the motion information MDout and the edge information EDout larger than the predetermined threshold value are detected from the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively, so motion picture response is able to be improved by pseudo-impulse drive, and compared to the case where adaptive gray-scale conversion is performed on luminance signals in all pixel regions as in the case of related art, the sense of flicker is able to be reduced. Moreover, the presence or absence of discontinuity along the time axis in the detected motion information MDin and the detected edge information EDout is determined in each pixel by the discontinuity detection/correction section 1434, and in the case where the presence of discontinuity in motion information MDin or the edge information EDin is determined, the motion information MDin and the edge information EDin are corrected so as to eliminate discontinuity, and are outputted as the motion information MDout and the edge information EDout, so irrespective of contents (the picture signal Din) of a picture or the presence or absence of a noise component, continuity along the time axis in the motion information or the edge information is able to be maintained. Therefore, irrespective of contents of a picture or the presence or absence of a noise component, compatibility between a reduction in the sense of flicker and an improvement in motion picture response is able to be achieved.

Although the present invention is described referring to the third embodiment, the invention is not limited thereto, and may be variously modified.

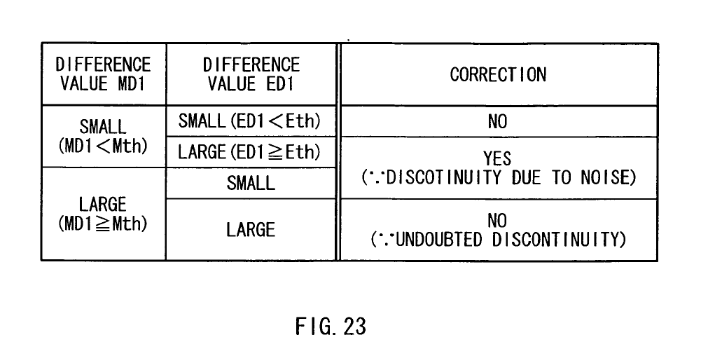

For example, in the above-described third embodiment, the case where the discontinuity motion information detection/correction section 1007 and the discontinuity edge information detection/correction section 1008 separately make a final determination according to the determination signals Jout1 and Jout2 as determination results by the discontinuity detection sections 1713 and 1813 to perform correction is described; however, for example, as illustrated in FIG. 14, the discontinuity determination section 1713 and the discontinuity determination section 1813 may exchange the determination information Jout1 and Jout2 with each other to complementarily make a final determination. Specifically, for example, as illustrated in FIG. 23, in the case where in the discontinuity determination sections 1713 and 1813, the presence of discontinuity in only one of the motion information MDin and the edge information EDin is determined (in the case where only one of the difference values MD1 and ED1 is equal to or larger than the threshold value Mth or Eth, and only one of the determination signals Jout1 and Jout2 indicates the determination of the presence of discontinuity), discontinuity determination sections 1713 and 1813 make a final determination that correction should be made because discontinuity supposed to be corrected is undoubtedly present, thereby as described in the above-described third embodiment, correction is performed so as to eliminate the discontinuity, while in the case where the presence of discontinuity in both of the motion information MDin and the edge information EDin is determined (in the case where both of the difference values MD1 and ED1 are equal to or larger than the threshold values Mth and Eth, and both of the determination signals Jout1 and Jout2 indicate the determination of the presence of discontinuity), the discontinuity determination sections 1713 and 1813 make a final determination that correction should not be made because discontinuity is generated due to noises or the like, thereby correction described in the above-describe third embodiment is not performed. In such a configuration, even if discontinuity due to noises or the like is present in only one of the motion information MDin and the edge information EDin, correction is prevented from being wrongly performed. In other words, determination whether or not discontinuity supposed to be corrected is undoubtedly present in the motion information MDin or edge information EDin is able to be made, so in addition to the effects in the above-described third embodiment, discontinuity determination accuracy is able to be improved.

Moreover, in the above-described third embodiment, the case where adaptive gray-scale conversion is selectively performed on a pixel region where both of the motion information MDout and the edge information EDout are larger than the predetermined threshold value as a conversion processing region (the detection region) is described; however, more typically, adaptive gray-scale conversion may be selectively performed on a pixel region where one or both of motion information MDout and the edge information EDout is larger than the predetermined threshold value as the conversion processing region (the detection region).

Further, in the above-described third embodiment, the case where one unit frame period includes two sub-frame periods SF1 and SF2 is described; however, the frame rate conversion section 1041 may perform frame rate conversion so that one unit frame period includes three or more sub-frame periods.

Moreover, in the above-described third embodiment, the liquid crystal display 1001 including the liquid crystal display panel 1002 and the backlight section 1003 as an example of the image display is described; however, the image processing apparatus of the invention is also applicable to any other image display, that is, for example, a plasma display (PDP: Plasma Display Panel) or an EL (ElectroLuminescence) display.

### Fourth Embodiment

Next, a fourth embodiment of the invention will be described below.

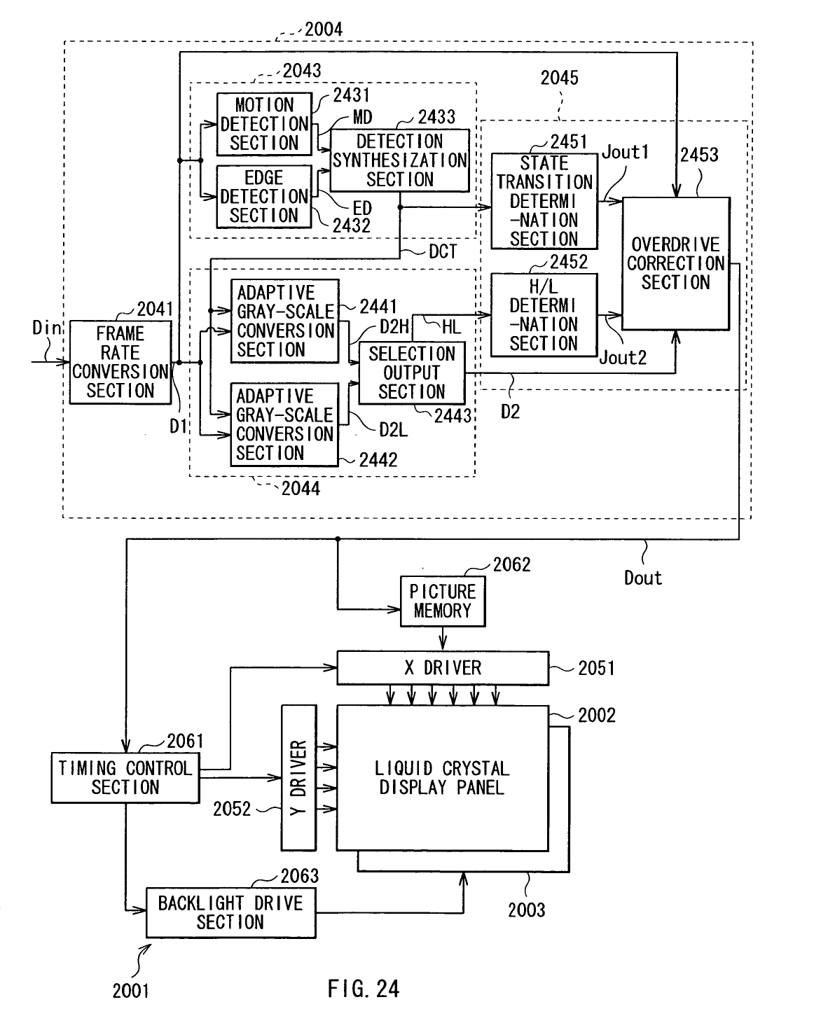

FIG. 24 illustrates the whole configuration of an image display (a liquid crystal display 2001) including an image processing apparatus (an image processing section 2004) according to the fourth embodiment of the invention. The liquid crystal display 2001 includes a liquid crystal display panel 2002, a backlight section 2003, the image processing section 2004, a picture memory 2062, an X driver 2051, a Y driver 2052, a timing control section 2061 and a backlight control section 2063. In addition, an image processing method according to the embodiment is embodied by the image processing apparatus according to the embodiment, and will be also described below.

The liquid crystal display panel 2002 displays a picture corresponding to, for example, a picture signal Din by a drive signal supplied from the X driver 2051 and the Y driver 2052 which will be described later, and includes a plurality of pixels (not illustrated) arranged in a matrix form.

The backlight section 2003 is a light source applying light to the liquid crystal display panel 2002, and includes, for example, a CCFL (Cold Cathode Fluorescent Lamp), an LED (Light Emitting Diode) or the like.

The image processing section 2004 performs predetermined image processing which will be described later on the picture signal Din (a luminance signal) from outside to generate a picture signal Dout, and includes a frame rate conversion section 2041, a conversion region detection section 2043, a gray-scale conversion section 2044 and an overdrive processing section 2045.

The frame rate conversion section 2041 converts the frame rate (for example, 60 Hz) of the picture signal Din into a higher frame rate (for example 120 Hz). Specifically, the unit frame period (for example, ( 1/60) seconds) of the picture signal Din is divided into a plurality of (for example, two) sub-frame periods (for example, ( 1/120) seconds) to generate a picture signal D1 (a luminance signal) consisting of, for example, two sub-frame periods. In addition, as a method of generating the picture signal D1 by such frame rate conversion, for example, a method of producing an interpolation frame by motion detection or a method of producing an interpolation frame by simply duplicating the original video signal Din is considered.

The conversion region detection section 2043 detects motion information (a motion index) MD and edge information (an edge index) ED for each pixel in each sub-frame period from the picture signal D1 supplied from the frame rate conversion section 1041, and includes a motion detection section 2431, an edge information detection section 2432 and a detection synthesization section 2433.

The motion detection section 2431 detects motion information MD for each pixel in each sub-frame period from the picture signal D1, and the edge detection section 2432 detects edge information ED for each pixel in each sub-frame period from the picture signal D1. The detection synthesization section 2433 combines the motion information MD detected by motion detection section 2431 and the edge information ED detected by the edge detection section 2432, and generates and outputs a detection synthesization result signal DCT by performing various adjustment processes (a detection region expanding process, a detection region rounding process, an isolated point detection process or the like). The detection operation by the conversion region detection section 2043 will be described in detail later.

In addition, as a motion detection method by the motion detection section 2431, for example, a method of detecting a motion vector through the use of a block matching method, a method of detecting a motion vector between sub-frames through the use of a difference signal between sub-frames, or the like is cited. Moreover, as an edge detection method by the edge detection section 2432, a method of performing edge detection by detecting a pixel region where a luminance level (gray scale) difference between a pixel and its neighboring pixel is larger than a predetermined threshold value in each sub-frame period, or the like is cited.

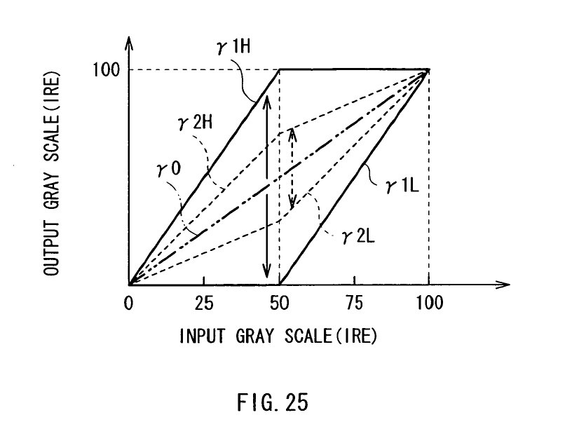

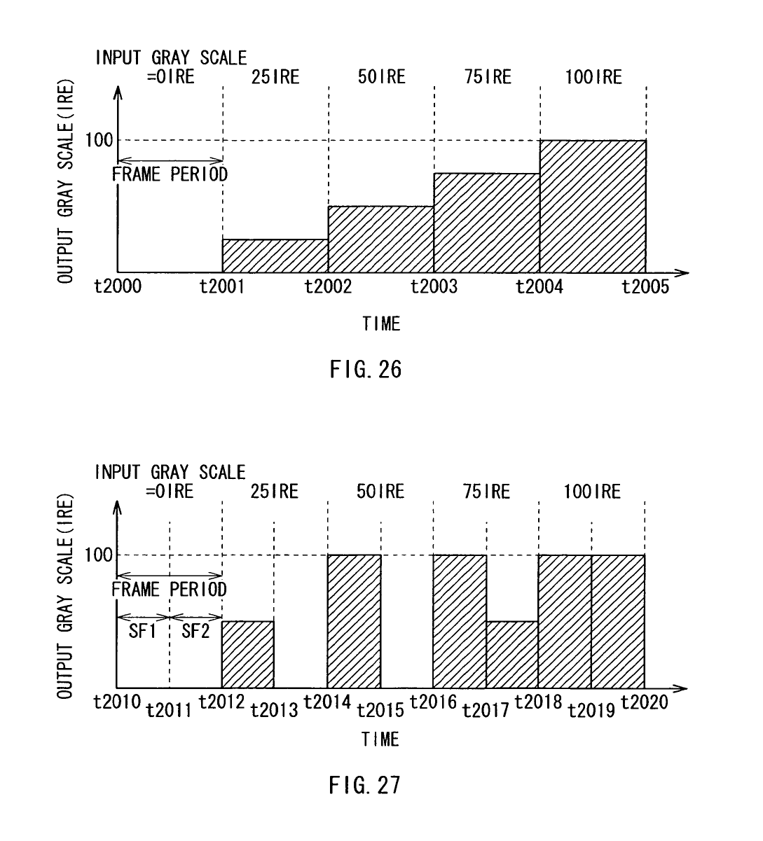

The gray-scale conversion section 2044 selectively performs adaptive gray-scale conversion which will be described later on a picture signal (a luminance signal) in a pixel region where the motion information MD and the edge information ED larger than a predetermined threshold value are detected from the inputted picture signal D1 in response to the detection synthesization result signal DCT supplied from the conversion region detection section 2043, and includes two adaptive gray-scale conversion sections 2441 and 2442 and a selection output section 2443. Specifically, for example, as illustrated in FIG. 25, the adaptive gray-scale conversion sections 2441 and 2442 perform gray-scale conversion from an (input/output) gray-scale conversion characteristic (a luminance γ characteristic) y0 of the picture signal D1 to a luminance γ characteristic γ1H having higher luminance than original luminance and a luminance γ characteristic γ1L having lower luminance than the original luminance, respectively, and the selection output section 2443 alternately selects and outputs picture signals (luminance signals) D21H and D21L corresponding to the two luminance γ characteristics γ1H and γ1L, respectively, in each sub-frame period, thereby a picture signal (a luminance signal) D2 is generated and outputted. Therefore, in the case where, for example, the luminance gradation level (input gray scale) of the picture signal D1 is temporally changed as illustrated in FIG. 26 (timings t2001 to t2005), the luminance gradation level (the input gray scale) of the picture signal D2 obtained by adaptive gray-scale conversion becomes, for example, as illustrated in FIG. 27 (timings t2010 to t2020), and a high luminance period (a sub-frame period SF1) in which a picture signal D21H on the basis of the luminance γ characteristic γ1H having higher luminance is outputted and a low luminance period (a sub-frame period SF2) in which a picture signal D21L on the basis of the luminance γ characteristic γ1L having lower luminance is outputted are alternately allocated in each frame period, respectively.

In addition, adaptive gray-scale conversion may be performed on the luminance γ characteristic γ0 of the picture signal D1 through the use of, for example, luminance γ characteristics γ2H and γ2L in FIG. 25 instead of the luminance γ characteristics γ1H and γ1L. However, an effect of improving motion picture response is higher in the case where adaptive gray-scale conversion is performed through the use of the luminance γ characteristics γ1H and γ1L than in the case where adaptive gray-scale conversion is performed through the use of the luminance γ characteristics γ2H and γ2L, so the luminance γ characteristics γ1H and γ1L is preferably used. Moreover, in FIG. 25, the luminance γ characteristic γ0 is a linear straight line; however, the luminance γ characteristic γ0 may be, for example, a nonlinear γ2.2 curve, or the like.

The overdrive processing section 2045 determines, one after another for each pixel, a following state transition mode among a plurality of state transition modes which will be described later on the basis of a detection synthesization result signal DCT supplied from the conversion region detection section 2043 and a signal (a selection signal HL which will be described later) obtained from the gray-scale conversion section 2044, and generates and outputs the picture signal Dout by adding an overdrive amount according to a determined state transition mode onto the picture signal D2 supplied from the gray-scale conversion section 2044 for each pixel, and includes a state transition determination section 2451, an H/L determination section 2452 and an overdrive correction section 2453.

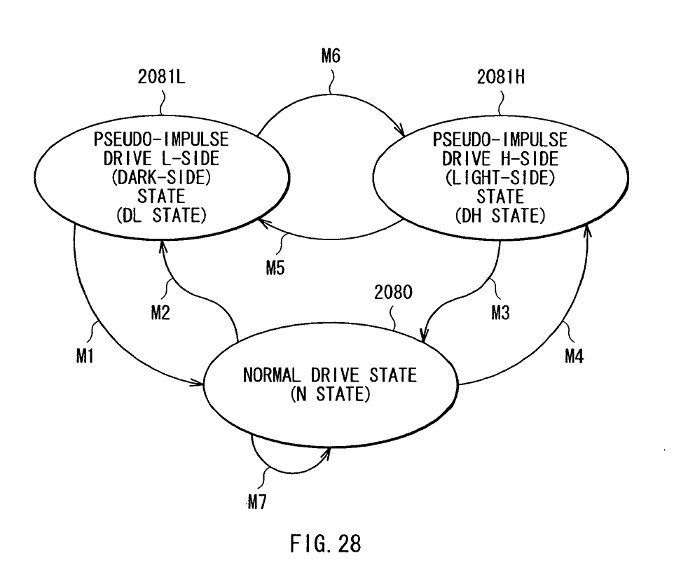

For example, as illustrated in FIG. 28, the state transition determination section 2451 determines a following state transition mode among a plurality of state transition modes each defined as a normal drive state (an N state) 2080 in which improved pseudo-impulse drive is not performed, improved pseudo-impulse drive states (D states; an improved pseudo-impulse drive H-side (light-side) state (a DH state) indicating a high luminance state and an improved pseudo-impulse drive L-side (dark-side) state (a DL state) indicating a low luminance state) 2081H and 2081L on the basis of the detection synthesization result signal DCT supplied from the conversion region detection section 2043, thereby to output a determination signal Jout1. Specifically, the state transition determination section 2451 determines, for each pixel, a following state transition mode among four state transition modes each defined as a state transition mode from the N state to the D state (N/D transition; N/DL transition M2 or N/DH transition M4 in the drawing) and a state transition mode from the D state to the N state (D/L transition; DUN transition M1 or DH/N transition M3 in the drawing), a state transition mode from the D state to the D state (D/D transition; DH/DL transition M5 or DL/DH transition M6 in the drawing), and a state transition mode from the N state to the N state (N/N transition; N/N transition M7 in the drawing) indicating a luminance level change between sub-frames in the normal drive state.

The H/L determination section 2452 determines, for each pixel, whether a picture signal subjected to adaptive gray-scale conversion is in the high luminance state (the DH state) or the low luminance state (the DL state) by obtaining a selection signal HL (a signal indicating whether a picture signal D2H or a picture signal D2L is selected and outputted at present by, for example, “H” or “L”) from the selection output section 2443 in the gray-scale conversion section 2044 to output a determination signal Jout2.

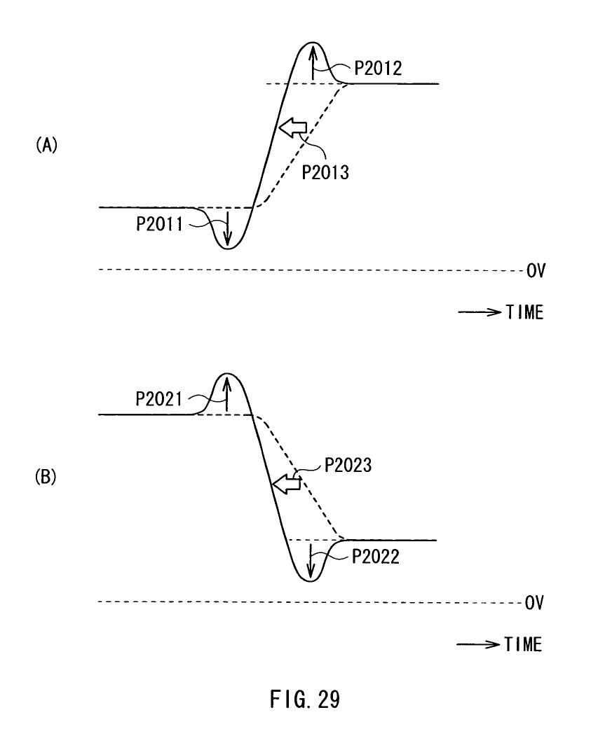

The overdrive correction section 2453 makes a final determination of the following state transition mode for each pixel among seven state transition modes, that is, for example, as illustrated in FIG. 28, DL/N transition M1, N/DL transition M2, DH/N transition M3, N/DH transition M4, DH/DL transition M5, DL/DH transition M6 and N/N transition M7, and the overdrive correction section 2453 generates and outputs the picture signal (the luminance signal) Dout by adding an overdrive amount according to a determined state transition mode (for example, overdrive amounts illustrated by reference numerals P2011, P2012, P2021 and P2022 in FIGS. 29(A) and (B)) onto the picture signal D2 which is obtained by gray-scale conversion and supplied from the gray-scale conversion section 2044 through the use of a lookup table (LUT) which will be described later. In addition, the configuration of the overdrive correction section 2453 and the operation of the overdrive processing section 45 will be described in detail later.

The picture memory 2062 is a frame memory storing the picture signal Dout obtained by adding the overdrive amount and supplied from the image processing section 2004 for each pixel in each sub-frame period. The timing control section (a timing generator) 2061 controls the drive timings of the X driver 2051, the Y driver 2052 and the backlight drive section 2063 on the basis of the picture signal Dout. The X driver (data driver) 2051 supplies a drive voltage corresponding to the picture signal Dout to each pixel of the liquid crystal display panel 2002. The Y driver (gate driver) 2052 line-sequentially drives each pixel in the liquid crystal display panel 2002 along a scanning line (not illustrated) according to timing control by the timing control section 2061. The backlight drive section 2063 controls the lighting operation of the backlight section 2003 according to timing control by the timing control section 2061.

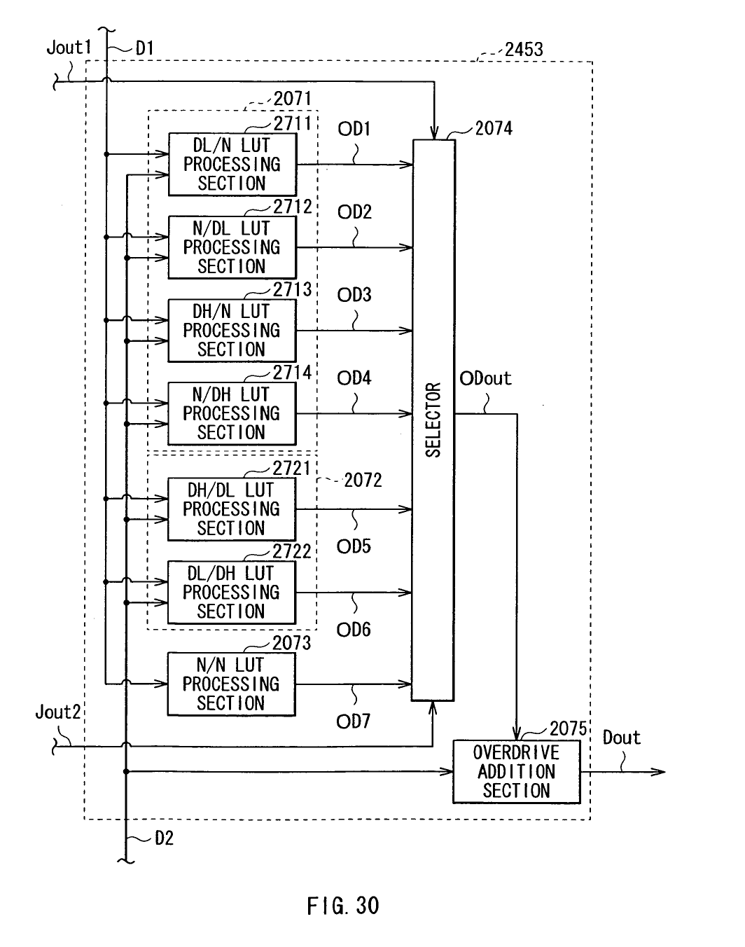

Next, referring to FIGS. 26 to 31, the configuration of the overdrive correction section 2453 will be described in detail below. Here, FIG. 30 illustrates a block configuration of the overdrive correction section 2453.

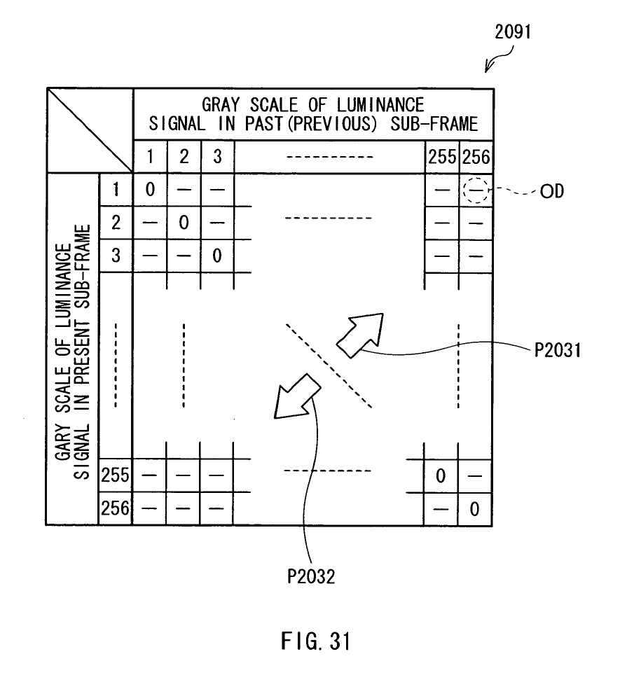

The overdrive correction section 2453 obtains one or more of the original picture signals D1 before adaptive gray-scale conversion and the picture signals D2 obtained by adaptive gray-scale conversion in two sub-frame period, that is, the present sub-frame period and the previous sub-frame period, and, for example, as illustrated in FIG. 31, the overdrive correction section 2453 includes LUT processing sections holding LUTs 2091 for the above-described seven state transition modes relating a gradation level difference between picture signals in sub-frames (a gradation level difference between the gray scale of a picture signal (a luminance signal) in the present sub-frame and the gray scale of a luminance signal in the past (previous) sub-frame) to an overdrive amount OD to be added. Specifically, the overdrive correction section 2453 includes a D/N LUT processing section 2071 holding an LUT for a state transition mode between the N state and the D state, a D/D LUT processing section 2072 holding an LUT for a state transition mode between the DH state and the DL state, and an N/N LUT processing section 2073 holding an LUT for a state transition mode between the N states. As in the case of the LUT 2091 illustrated in FIG. 31, each of the LUTs is set for each state transition mode in advance so that when a gradation level difference between the picture signals in the sub-frames is 0, the overdrive amount OD to be added is 0, and as indicated by arrows P2031 and P2032 in the drawing, the overdrive amount OD to be added increases with increase in the gradation level difference. Moreover, the LUT between the N states is established so that the overdrive amount OD which to be added is set to be larger in the LUT between the N state and the D state or the LUT between the DH state and the DL state than in the LUT between the N states.

The D/N LUT processing section 2071 includes a DL/N LUT processing section 2711 outputting an overshoot amount OD1 to be added at the time of DL/N transition M1 by applying the picture signals D1 and D2 in two successive sub-frames to an LUT for the DL/N transition M1, an N/DL LUT processing section 2712 outputting an overshoot amount OD2 to be added at the time of N/DL transition M2 by applying the picture signals D1 and D2 in two successive sub-frames to an LUT for the N/DL transition M2, a DH/N LUT processing section 2713 outputting an overshoot amount OD3 to be added at the time of the DH/N transition M3 by applying the picture signals D1 and D2 in two successive sub-frames to an LUT for the DH/N transition M3, and an N/DH LUT processing section 2714 outputting an overshoot amount OD4 to be added at the time of the N/DH transition M4 by applying the picture signals D1 and D2 in two successive sub-frames to an LUT for the N/DH transition M4. Moreover, the D/D LUT processing section 2072 includes a DH/DL LUT processing section 2721 outputting an overshoot amount OD5 to be added at the time of the DH/DL transition M5 by applying the picture signals D2 in two successive sub-frames to an LUT for the DH/DL transition M5, and a DL/DH LUT processing section 2722 outputting an overshoot amount OD6 to be added at the time of the DL/DH transition M6 by applying the picture signals D2 in two successive sub-frames to an LUT for the DL/DH transition M6. Further, the N/N LUT processing section 2073 outputs an overshoot amount OD7 to be added at the time of the N/N transition M7 by applying the picture signals D1 in two successive sub-frames to an LUT for the N/N transition M7.

The overdrive correction section 2453 also includes a selector 2074 and an overdrive addition section 2075. The selector 2074 makes a final determination of a state transition mode in which the picture signal is among the seven state transition modes for each pixel by applying the determination signal Jout1 supplied from the state transition determination section 2451 and the determination signal Jout2 supplied from the H/L determination section 2452 to a predetermined true table which will be described later, thereby one overshoot amount among the overdrive amounts OD1 to OD7 outputted from the LUT processing sections according to the state transition modes is determined to be selected and outputted as an overdrive amount ODout to be added.

The overdrive addition section 2075 adds the overdrive amount ODout selected and outputted from the selector 2074 onto the picture signal D2 obtained by adaptive gray-scale conversion and supplied from the gray-scale conversion section 2044, and outputs the picture signal D2 as the picture signal Dout.

Herein, the liquid crystal display panel 2002 and the backlight section 2003 correspond to specific examples of “a display means” in the invention. Moreover, the frame rate conversion section 2041 corresponds to a specific example of “a frame division means” in the invention, and the conversion region detection section 2043 corresponds to a specific example of “a detection section” in the invention, and the gray-scale conversion section 2044 corresponds to a specific example of “a gray-scale conversion means” in the invention. Further, the overdrive processing section 2045 corresponds to a specific example of “a determination means” and “an addition means” in the invention.

Next, operations of the image processing section 2004 having such a configuration and the whole liquid crystal display 2001 of the embodiment will be described in detail below.

First, referring to FIGS. 24 to 27 and FIG. 32, the basic operations of the image processing section 4 and the whole liquid crystal display 2001 will be described below.

In the whole liquid crystal display 2001 of the embodiment, as illustrated in FIG. 24, image processing is performed on the picture signal Din supplied from outside by the image processing section 2004, thereby the picture signal Dout is generated.

Specifically, first, the frame rate conversion section 2041 converts the frame rate (for example, 60 Hz) of the picture signal Din into a higher frame rate (for example 120 Hz). More specifically, the unit frame period (for example, ( 1/60) seconds) of the picture signal Din is divided into two sub-frame periods (for example, ( 1/120) seconds) to generate the picture signal D1 consisting of two sub-frame periods SF1 and SF2.

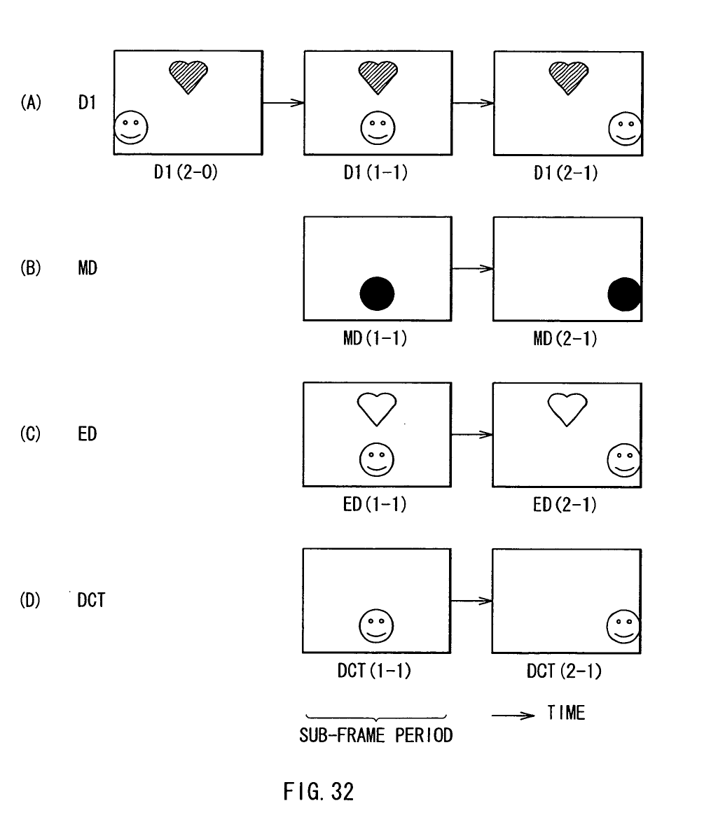

Next, in the conversion region detection section 2043, for example, as illustrated in FIG. 32, the motion information MD and the edge information ED are detected, and the conversion region is detected on the basis of the information. Specifically, when, for example, the picture signal D1 (picture signals D1(2-0), D1(1-1) and D1(2-1)) as illustrated in FIG. 32(A) as a base of a displayed picture is inputted, for example, motion information MD (motion information MD(1-1) and MD(2-1)) as illustrated in FIG. 32(B) is detected by the motion detection section 2431, and, for example, edge information ED (edge information ED(1-1) and ED(2-1)) as illustrated in FIG. 32(C) is detected by the edge detection section 2432. Then, for example, the detection synthesization result signals DCT (detection synthesization result signals DCT(1-1) and DCT(2-1)) as illustrated in FIG. 32(D) are generated by the detection synthesization section 2433 on the basis of the motion information MD and the edge information ED detected in such a manner. Thereby a region subjected to gray-scale conversion (a conversion region) by the gray-scale conversion section 2044, that is, an edge region in a motion picture which causes a decline in motion picture response is specified.

Next, in the gray-scale conversion section 2044, on the basis of the picture signal D1 supplied from the frame rate conversion section 2041 and the detection result synthesization signal DCT supplied from the conversion region detection section 2043, adaptive gray-scale conversion (gray-scale conversion corresponding to improved pseudo-impulse drive) using, for example, the luminance γ characteristics γ1H and γ1L illustrated in FIG. 25 is performed on a picture signal in a pixel region (a detection region; specifically, for example, an edge region in a motion picture) in which the motion information MD and the edge information ED larger than a predetermined threshold value are detected from the picture signal D1, and on the other hand, adaptive gray-scale conversion is not performed on a picture signal in a pixel region (a pixel region other than the detection region) in which the motion information MD and the edge information ED smaller than the predetermined threshold value are detected from the picture signal D1, and the picture signal D1 using the luminance characteristic γ0 is outputted as it is. In other words, adaptive gray-scale conversion is selectively performed on a picture signal in a pixel region where the motion information MD and the edge information ED are larger than the predetermined threshold value in the picture signal D1 to perform pseudo-impulse drive.

Therefore, in the pixel region (the detection region) on which adaptive gray-scale conversion is performed, in the case where, for example, the luminance gradation level (an input gray scale) of the picture signal D1 is temporally changed as illustrated in FIG. 26 (timings t2001 to t2005), for example, as illustrated in FIG. 27 (timings t2010 to t2020), adaptive gray-scale conversion is selectively performed on the luminance gradation level (the input gray scale) of the picture signal D2 obtained by adaptive gray-scale conversion so that, while allowing the time integral value of luminance within the unit frame period to be maintained as it is, the high luminance period (the sub-frame period SF1) having a luminance level higher than the luminance level of the original picture signal D1 and the low luminance period (the sub-frame period SF2) having a luminance level lower than the luminance level of the original picture signal D1 are allocated to sub-frame periods in the unit frame period, respectively. In other words, pseudo-impulse drive is performed without sacrificing display luminance, and low motion picture response due to hold-type display is overcome.

Then, illumination light from the backlight section 2003 is modulated by a drive voltage (a pixel application voltage) outputted from the X driver 2051 and the Y driver 2052 to each pixel on the basis of the picture signal (luminance signal) Dout obtained by performing gray-scale conversion on the picture signal (the luminance signal) D2 in such a manner and outputted from the image processing section 2004 to be outputted from the liquid crystal display panel 2002 as display light. Thus, image display is performed by the display light corresponding to the picture signal Din.

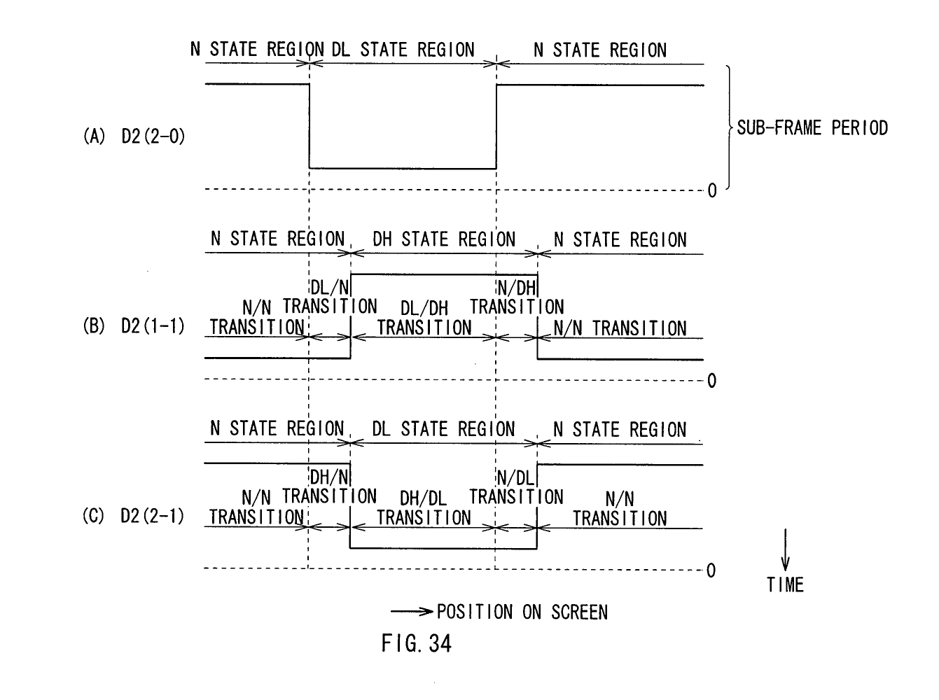

Next, referring to FIGS. 24 to 34, the operation of the overdrive processing section 2045 as one of characteristic points of the invention will be described in detail below. Herein, FIGS. 34(A) to (C) illustrate a time change in the picture signal D2 (D2(2-0), D2(1-1) and D2(2-1)) in each position on a screen in each sub-frame period.

In the overdrive processing section 2045 of the embodiment, first, for example, in the case where a plurality of state transition modes as illustrated in FIG. 28 are set, on the basis of the detection synthesization result signal DCT supplied from the conversion region detection section 2043, the state transition determination section 2451 determines, for each pixel, a following state transition mode among four state transition modes, that is, the N/D transition (N/DL transition M2 or the N/DH transition M2 in the drawing), D/L transition (DL/N transition M1 or the DH/N transition M3 in the drawing), the D/D transition (DH/DL transition M5 or the DL/DH transition M6 in the drawing) and the N/N transition (the N/N transition M7 in the drawing), thereby the determination signal Jout1 indicating a determination result is outputted. On the other hand, the H/L determination section 2452 determines whether the picture signal subjected to adaptive gray-scale conversion is in the high luminance state (the DH state) or the low luminance state (the DL state) for each pixel by obtaining the selection signal HL from the selection output section 2443, thereby the determination signal Jout2 is outputted.

Next, in LUT processing sections 2711 to 2714, 2721, 2722 and 2723 in the overdrive correction section 2453, one or more of the original picture signals D1 before adaptive gray-scale conversion and the picture signals D2 obtained by adaptive gray-scale conversion in two sub-frame periods, that is, the present sub-frame period and the previous sub-frame period is supplied, and the picture signals are applied to the LUTs (refer to FIG. 31) which are set according to the state transition modes, thereby the overdrive amounts OD1 to OD7 to be added in the state transition modes are outputted.

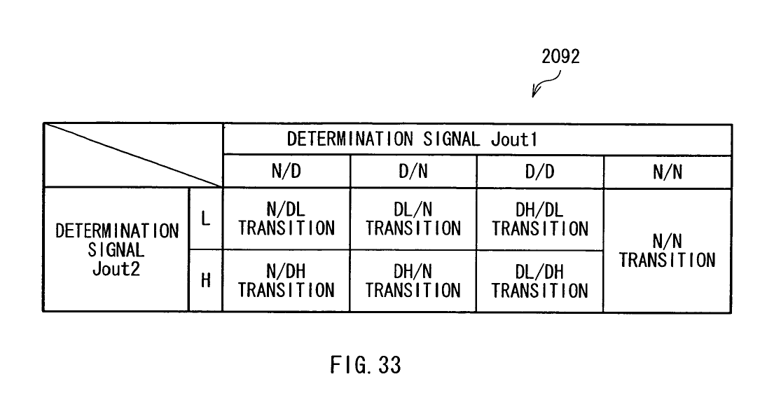

Next, in the selector 2074, the determination signal Jout1 supplied from the state transition determination section 2451 and the determination signal Jout2 supplied from the H/L determination section 2452 are applied to, for example, the true table 2092 as illustrated in FIG. 33, thereby a final determination of the state transition mode in which the picture signal is among seven state transition modes, and one overshoot amount corresponding to the finally determined state transition mode is selected from the overdrive amounts OD1 to OD7 outputted from the LUT processing sections and the overshoot amount is outputted as the overdrive amount ODout to be added. Specifically, in the case where the determination signal Jout1 indicates that transition is “N/D transition”, when the determination signal Jout2 is “L”, a final determination that the transition is “N/DL transition” is made, and on the other hand, when the determination signal Jout2 is “H”, a final determination that the transition is “N/DH transition” is made. Moreover, in the case where the determination signal Jout1 indicates that the transition is “D/N transition”, when the determination signal Jout2 is “L”, a final determination that the transition is “DL/N transition” is made, and on the other hand, when the determination signal Jout2 is “H”, a final determination that the transition is “DH/N transition” is made. Further, in the case where the determination signal Jout1 indicates that transition is “D/D transition”, when the present determination signal Jout2 is “L”, a final determination that the transition is “DH/DL transition” is made, and on the other hand, when the present determination signal Jout2 is “H”, a final determination that the transition is “DL/DH transition” is made. Moreover, in the case where the determination signal Jout1 indicates that transition is “N/N transition”, irrespective of the value of the determination signal Jout2, a final determination that the transition “N/N transition” is made.

Next, in the overdrive addition section 2075, the overdrive amount ODout selected and outputted by the selector 2074 is added onto the picture signal D2 obtained by adaptive gray-scale conversion and supplied from the gray-scale conversion section 2044 for each pixel, thereby the picture signal Dout is outputted. Then, the picture signal Dout obtained by adding the overdrive amount ODout onto the picture signal D2 is supplied to the picture memory 2062 and the timing control section 2061, thereby overdrive on the basis of the overdrive amount ODout is performed in each pixel in the liquid crystal display panel 2002.

Therefore, for example, as in the case of the picture signals D2(2-0), D2(1-1) and D2(2-1) as illustrated in FIGS. 34(A) to (C), when the case where an edge region (which is “a DL state region” or “a DH state region” in the drawings, and which is an image region detected as a conversion region by the conversion region detection section 2043) in a moving picture moves by each sub-frame period on a screen is considered, as illustrated in the drawings, seven state transition modes, that is, the DL/N transition M1, the N/DL transition M2, the DH/N transition M3, the N/DH transition M4, the DH/DL transition M5, the DL/DH transition M6 and N/N transition M7 are present, and appropriate overdrive is performed for each pixel according to the state transition modes (refer to FIG. 29); therefore, for example, as illustrated by arrows P2013 and 2023 in FIGS. 29(A) and (B), the motion picture response of a liquid crystal in each pixel is improved.

As described above, in the image processing section 2004 of the embodiment, the unit frame period of the input picture signal Din is divided into a plurality of sub-frame periods SF1 and SF2 to generate the picture signal D1 by frame rate conversion, and the motion information and edge information of the picture signal D1 are detected in each pixel. Then, adaptive gray-scale conversion is selectively performed on a picture signal in a pixel region (the detection region) in which the motion information MD and the edge information ED larger than the predetermined threshold value are detected from the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively. As adaptive gray-scale conversion is selectively performed on the picture signal in the pixel region (the detection region) in which the motion information MD and the edge information ED are larger than the predetermined threshold value in such a manner, while motion picture response is improved by pseudo-impulse drive in the detection region, the sense of flicker is reduced by normal drive in a pixel region other than the detection region. Therefore, compared to the case where adaptive gray-scale conversion is performed on the picture signals in all pixel region, while high motion picture response is maintained, the sense of flicker is reduced.

Moreover, the overdrive correction section 2453 determines, one after another for each pixel, a following state transition mode among seven state transition modes (the DL/N transition M1, the N/DL transition M2, the DH/N transition M3, the N/DH transition M4, the DH/DL transition M5, the DL/DH transition M6 and the N/N transition M7), and the overdrive amount ODout corresponding to the determined state transition mode is added onto the picture signal D2 obtained by adaptive gray-scale conversion for each pixel, so an appropriate overdrive amount according to the state transition mode is able to be added.

As described above, in the embodiment, the unit frame period of the input picture signal Din is divided into a plurality of sub-frame periods SF1 and SF2 to generate the picture signal D1 by frame rate conversion, and the motion information and edge information of the picture signal D1 are detected in each pixel, and adaptive gray-scale conversion is selectively performed on the picture signal in the pixel region (the detection region) in which the motion information MD and the edge information ED larger than the predetermined threshold value are detected from the picture signal D1 so that, while allowing the time integral value of luminance within the unit frame period to be maintained as it is, the high luminance period (the sub-frame period SF1) and the low luminance period (the sub-frame period SF2) are allocated to the sub-frame periods SF1 and SF2 in the unit frame period, respectively, so motion picture response is able to be improved by pseudo-impulse drive, and compared to the case where adaptive gray-scale conversion is performed on luminance signals in all pixel regions as in the case of related art, the sense of flicker is able to be reduced. Moreover, a following state transition mode among seven state transition modes is determined one after another for each pixel, and the overdrive amount ODout corresponding to the determined state transition mode is added onto the picture signal D2 obtained by adaptive gray-scale conversion for each pixel, so an appropriate overdrive amount according to the state transition mode is able to be added, and irrespective of the state transition mode, optimum overdrive is able to be performed. Therefore, while the sense of flicker is reduced, motion picture response is able to be effectively improved.

Moreover, the lookup tables (LUT) for state transition modes relating a gradation level difference between picture signals in sub-frames to the overdrive amount OD to be added are prepared in advance, and the overdrive amount ODout to be added onto the picture signal obtained by adaptive gray-scale conversion is determined on the basis of the determined state transition mode by selecting one of the overdrive amounts OD1 to OD7 defined by the LUTs, so an appropriate overdrive amount is able to be easily determined.

As described above, although the present invention is described referring to the fourth embodiment, the invention is not limited thereto, and may be variously modified.

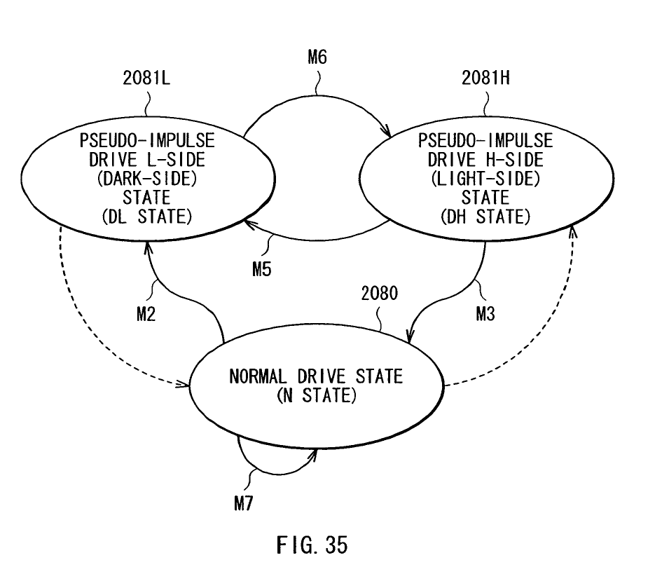

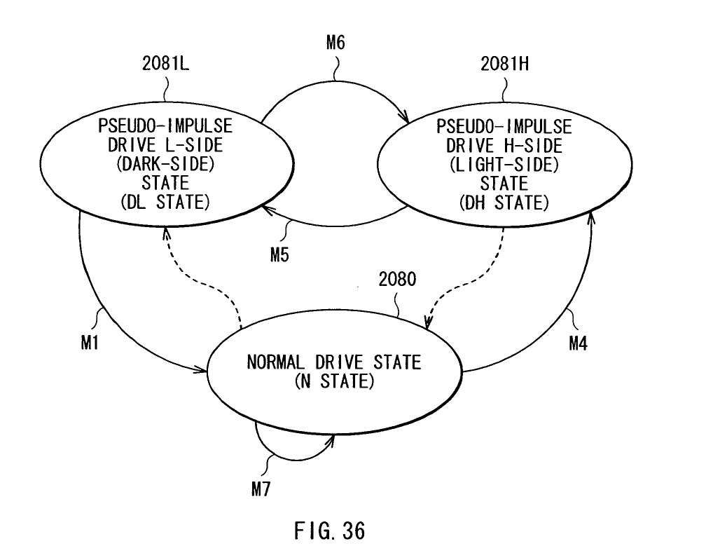

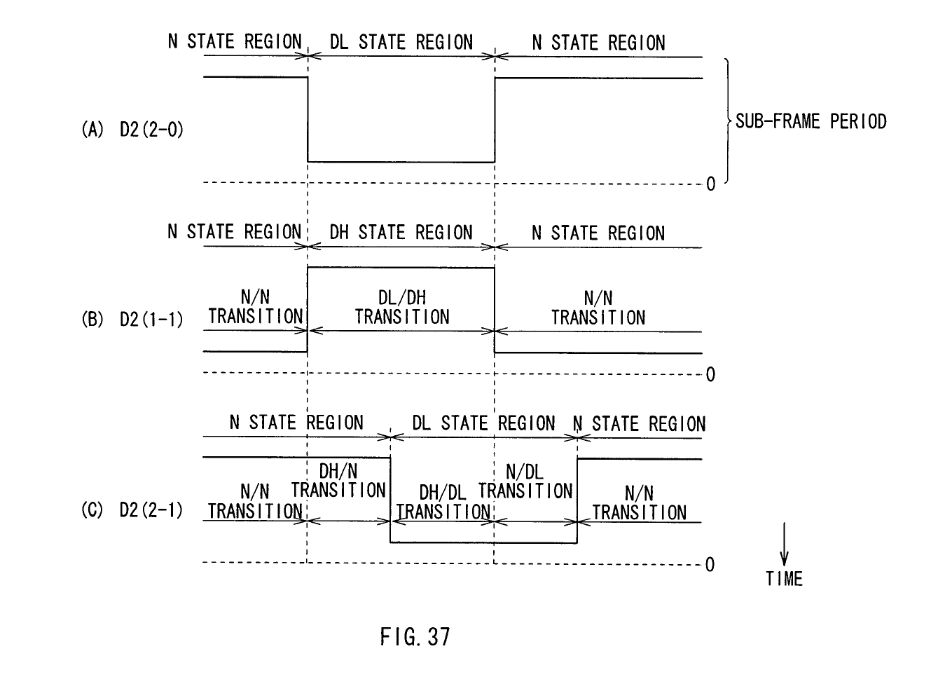

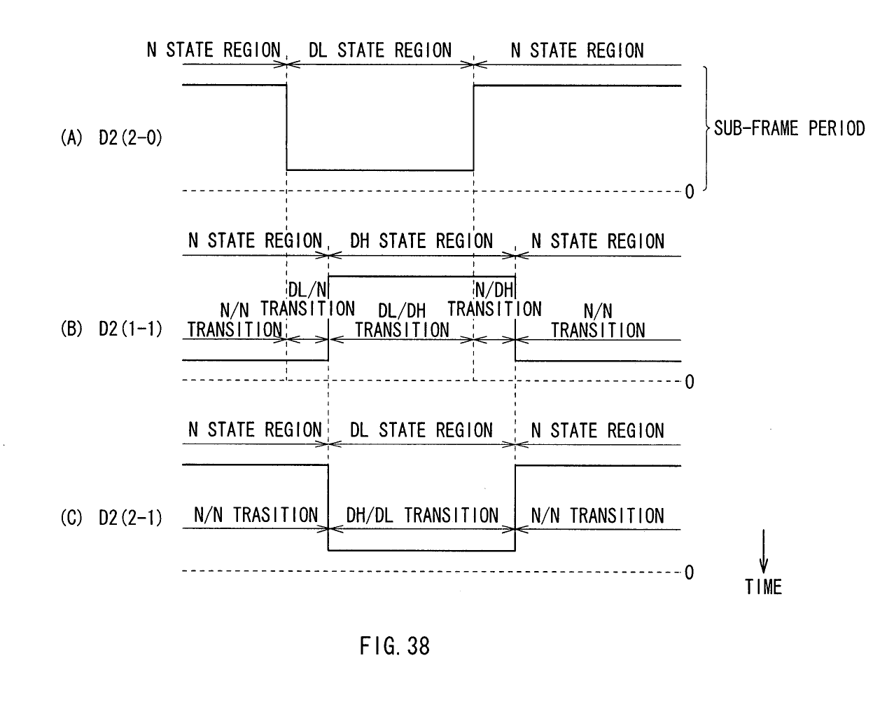

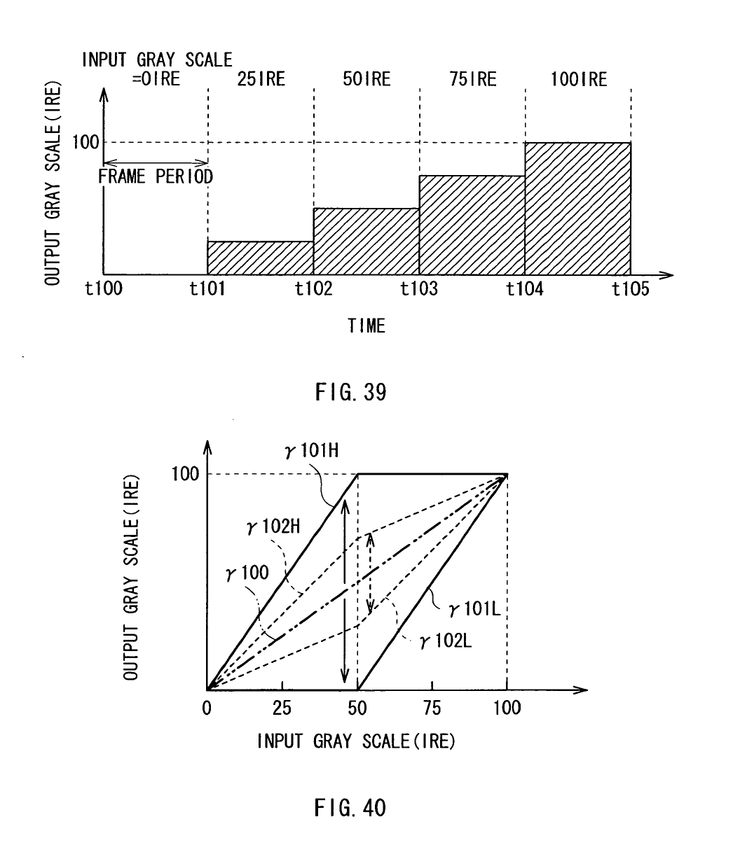

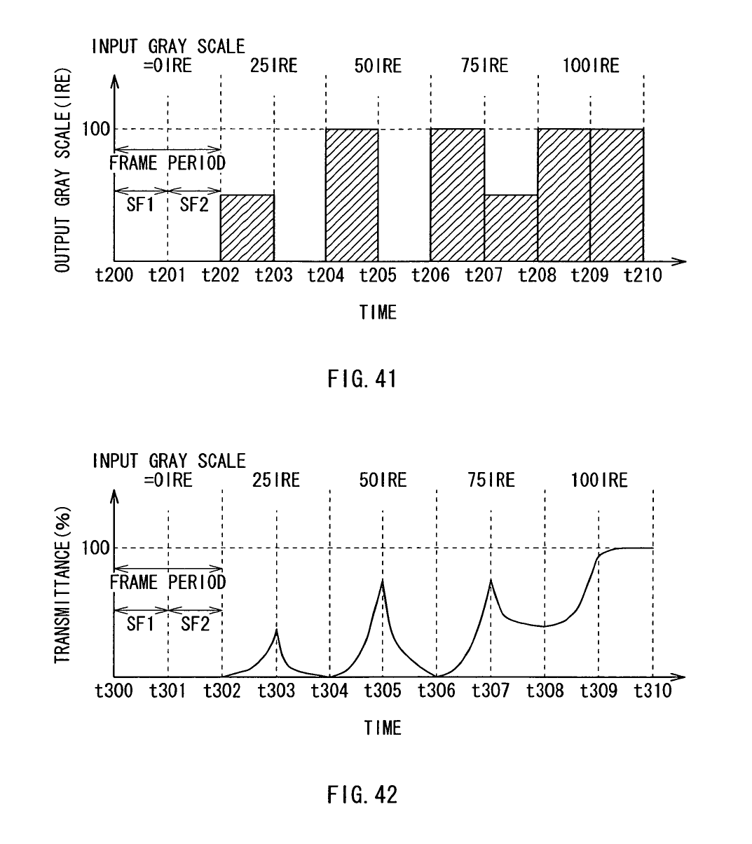

For example, in the above-described fourth embodiment, the case where as a plurality of state transition modes, seven state transition modes (the DL/N transition M1, the N/DL transition M2, the DH/N transition M3, the N/DH transition M4, the DH/DL transition M5, the DL/DH transition M6 and the N/N transition M7) are set is described; however, the number of state transition modes is not limited thereto, and, for example, as illustrated in FIG. 35, as a plurality of state transition modes, five state transition modes (the N/DL transition M2, the DH/N transition M3, the DH/DL transition M5, the DL/DH transition M6 and the N/N transition M7) may be set, or, for example, as illustrated in FIG. 36, as a plurality of state transition modes, another combination of five state transition modes (the DL/N transition M1, the N/DH transition M4, the DH/DL transition M5, the DL/DH transition M6 and the N/N transition M7) may be set. In such a configuration, compared to the above-described fourth embodiment, the number of state transition modes is reduced by two, so the configuration of the overdrive processing section 2045 is able to be simplified, compared to the above-described fourth embodiment, and a processing load in the overdrive processing section 2045 is able to be reduced. In addition, in these cases, in the case of FIG. 35, for example, a motion picture edge region illustrated in FIG. 34 moves as illustrated in, for example, FIG. 37, and in the case of FIG. 36, the motion picture edge region moves as illustrated in, for example, FIG. 38. In other words, the movement of the motion picture edge region between some sub-frames (in the case of FIG. 37, between sub-frames indicated by the picture signals D2(2-0) and D2(1-1), and in the case of FIG. 38, between sub-frames indicated by the picture signals D2(1-1) and D2(2-1)) may be limited.

Moreover, in the above-described fourth embodiment, the case where the LUTs for the state transition modes relating a gradation level difference between the picture signals in sub-frames to the overdrive amount OD to be added are provided, and the overdrive amount ODout to be added onto the picture signal D2 obtained by adaptive gray-scale conversion is determined by selecting one of the overdrive amounts OD1 to OD7 defined by the LUTs on the basis of a determined state transition mode is described; however, for example, LUTs for the state transition modes relating a gradation level difference between picture signals in sub-frames to the gradation level of the picture signal Dout obtained by adding the overdrive amount may be provided, and the overdrive amount to be added onto the picture signal obtained by adaptive gray-scale conversion may be determined by selecting one of gradation levels of the luminance signals Dout obtained by adding the overdrive amounts defined by the LUTs on the basis of a determined state transition mode. In such a configuration, a signal selected and outputted by the selector 2074 becomes the picture signal Dout obtained by adding the overdrive amount as it is, so the overdrive addition section 2075 is not necessary, so compared to the above-described fourth embodiment, the apparatus configuration is able to be simplified.

Moreover, in the above-described fourth embodiment, the case where adaptive gray-scale conversion is selectively performed on a pixel region where both of the motion information MD and the edge information ED are larger than the predetermined threshold value as a conversion processing region (the detection region) is described; however, more typically, adaptive gray-scale conversion may be performed on a pixel region where one or both of the motion information MD and the edge information ED is larger than the predetermined threshold value as the conversion processing region (the detection region).

Further, in the above-described fourth embodiment, the case where one unit frame period includes two sub-frame periods SF1 and SF2 is described; however, the frame rate conversion section 2041 may perform frame rate conversion so that one unit frame period includes three or more sub-frame periods.

Moreover, in the above-described fourth embodiment, the liquid crystal display 2001 including the liquid crystal display panel 2002 and the backlight section 2003 as an example of the image display is described; however, the image processing apparatus of the invention is applicable to any other image display, that is, for example, a plasma display (PDP: Plasma Display Panel) or an EL (ElectroLuminescence) display.

1. An image processing apparatus being applied to an image display configured so that each pixel includes a plurality of sub-pixels, the image processing apparatus comprising:
a detection means for detecting a motion index and/or an edge index of an input picture for each pixel;
a frame division means for dividing a unit frame period of the input picture into a plurality of sub-frame periods; and
a gray-scale conversion means for selectively performing adaptive gray-scale conversion on a luminance signal in a pixel region where a motion index and/or an edge index larger than a predetermined threshold value is detected by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively,
wherein the gray-scale conversion means performs adaptive gray-scale conversion on luminance of each of the sub-pixels in a pixel so that the sub-pixels have different display luminance from each other within the pixel.

2. The image processing apparatus according to claim 1, wherein
the gray-scale conversion means converts the luminance signal of the input picture for each pixel into luminance signals for the sub-pixels while allowing a space integral value to be maintained as it is, and then performs the adaptive gray-scale conversion on each of the luminance signals for the sub-pixels.

3. The image processing apparatus according to claim 1, wherein
the gray-scale conversion means performs the adaptive gray-scale conversion on the luminance signal of the input picture, and then converts the luminance signal subjected to the adaptive gray-scale conversion for each pixel into luminance signals for the sub-pixels while allowing a space integral value to be maintained as it is.

4. The image processing apparatus according to claim 1, wherein
gray-scale conversion is performed on each sub-pixel so that the space integral values of display luminance of sub-pixels in each pixel is substantially equal to display luminance represented by the luminance signal of the input picture in the pixel.

5. The image processing apparatus according to claim 1, wherein
a gray-scale conversion characteristic of each sub-pixel is established so that a difference in display luminance between sub-pixels in each pixel is larger than a predetermined threshold value.

6. An image display comprising:
a detection means for detecting a motion index and/or an edge index of an input picture for each pixel;
a frame division means for dividing a unit frame period of the input picture into a plurality of sub-frame periods;
a gray-scale conversion means for selectively performing adaptive gray-scale conversion on luminance of a pixel where a motion index and/or an edge index larger than a predetermined threshold value is detected by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively,
a display means configured so that each pixel includes a plurality of sub-pixels, and for displaying a picture on the basis of a luminance signal subjected to adaptive gray-scale conversion by the gray-scale conversion means,
wherein the gray-scale conversion means performs adaptive gray-scale conversion on luminance of each of the sub-pixels in a pixel so that the sub-pixels have different display luminance from each other within the pixel.

7. An image processing method being applied to an image display configured so that each pixel includes a plurality of sub-pixels, the image processing method comprising:
a detection step of detecting a motion index and/or an edge index of an input picture for each pixel;
a frame division step of dividing a unit frame period of the input picture into a plurality of sub-frame periods; and
a gray-scale conversion step of selectively performing adaptive gray-scale conversion on luminance of a pixel where a motion index and/or an edge index larger than a predetermined threshold value is detected so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively,
wherein in the gray-scale conversion step, adaptive gray-scale conversion is performed on luminance of each of the sub-pixels in a pixel so that the plurality of sub have different display luminance from each other within the pixel.

8. An image processing apparatus comprising:
a detection means for detecting a motion index and/or an edge index of an input picture for each pixel;
a determination means for determining the presence or absence of discontinuity along a time axis in the detected motion index and/or the detected edge index for each pixel;
a correction means for, in the case where the presence of discontinuity in the motion index and/or the edge index is determined by the determination means, if necessary, correcting the motion index and/or the edge index for each pixel so as to eliminate the discontinuity;
a frame division means for dividing a unit frame period of the input picture into a plurality of sub-frame periods; and
a gray-scale conversion means for selectively performing adaptive gray-scale conversion on luminance of a pixel where a corrected motion index and/or a corrected edge index larger than a predetermined threshold value is detected so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively.

9. The image processing apparatus according to claim 8, wherein
the determination means calculates, for each pixel, a difference value between motion indexes in the sub-frames and/or a difference value between edge indexes in the sub-frames, and in the case where the difference values are equal to or larger than a predetermined threshold difference value, the determination means determines the presence of discontinuity in the motion index and/or the edge index, and
the correction means corrects the difference values in each pixel to be smaller than the threshold difference value, thereby to eliminate the discontinuity.

10. The image processing apparatus according to claim 8, wherein
the correction means calculates, for each pixel, average values of motion indexes and/or edge indexes in sub-frames previous to and subsequent to a sub-frame in which the presence of discontinuity is determined, and outputs the calculated average values as a corrected motion index and/or the corrected edge index.

11. The image processing apparatus according to claim 8, wherein
the correction means duplicates a motion index and/or an edge index in a sub-frame previous to a sub-frame in which the presence of the discontinuity is determined, and outputs the duplicated motion index and/or the duplicated edge index as the corrected motion index and/or a corrected edge index.

12. The image processing apparatus according to claim 8, wherein
in the case where the presence of discontinuity in only one of the motion index and the edge index is determined, the correction means performs correction so as to eliminate the discontinuity, while in the case where the presence of discontinuity in both of the motion index and the edge index is determined, the correction means does not perform correction.

13. An image display comprising:
a detection means for detecting a motion index and/or an edge index of an input picture for each pixel;
a determination means for determining the presence or absence of discontinuity along a time axis in the detected motion index and/or the detected edge index for each pixel;
a correction means for, in the case where the presence of discontinuity in the motion index and/or the edge index is determined by the determination means, if necessary, correcting the motion index and/or the edge index for each pixel so as to eliminate the discontinuity;
a frame division means for dividing a unit frame period of the input picture into a plurality of sub-frame periods;
a gray-scale conversion means for selectively performing, adaptive gray-scale conversion on luminance of a pixel where a corrected motion index and/or a corrected edge index larger than a predetermined threshold value is detected so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively; and
a display means for displaying a picture on the basis of a luminance signal subjected to adaptive gray-scale conversion by the gray-scale conversion means.

14. An image processing method comprising:
a detection step of detecting a motion index and/or an edge index of an input picture for each pixel;
a determination step of determining the presence or absence of discontinuity along a time axis in the detected motion index and/or the detected edge index for each pixel;
a correction step of, in the case where the presence of discontinuity in the motion index and/or the edge index is determined, if necessary, correcting the motion index and/or the edge index for each pixel so as to eliminate the discontinuity;
a frame division means for dividing a unit frame period of the input picture into a plurality of sub-frame periods; and
a gray-scale conversion step of selectively performing adaptive gray-scale conversion on a luminance of a pixel where a corrected motion index or a corrected edge index larger than a predetermined threshold value is detected so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively.

15. An image processing apparatus comprising:
a detection means for detecting a motion index and/or an edge index of an input picture for each pixel;
a frame division means for dividing a unit frame period of the input picture into a plurality of sub-frame periods;
a gray-scale conversion means for selectively performing adaptive gray-scale conversion on luminance of a pixel region where a motion index and/or an edge index larger than a predetermined threshold value is detected by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively;
a determination means for determining, one after another for each pixel, a following state transition mode among a plurality of state transition modes each defined as a state transition mode between any two of a normal luminance state, a high luminance state and a low luminance state, the normal luminance state being established by the original luminance signal not subjected to the adaptive gray-scale conversion by the gray-scale means, the high luminance state being established in the high luminance period, the low luminance state being established in the low luminance period; and
an addition means for adding, for each pixel, an overdrive amount according to a determined state transition mode onto a luminance signal subjected to adaptive gray-scale conversion by the gray-scale conversion means.

16. The image processing apparatus according to claim 15, wherein
the determination means determines the state transition mode based on both of a detection result by the detection section and a luminance signal subjected to the adaptive gray-scale conversion by the gray-scale conversion means.

17. The image processing apparatus according to claim 16, wherein
the determination means determines, for each pixel, which transition mode is coming up among a plurality of transition modes between an unconverted luminance state where the adaptive gray-scale conversion is not performed and converted luminance states where the adaptive gray-scale is performed, and
the determination means determines, for each pixel, whether the luminance signal subjected to the adaptive gray-scale conversion corresponds to the high luminance state or the low luminance state, thereby to make a final determination of the following state transition mode state for each pixel.

18. The image processing apparatus according to claim 15, wherein
the addition means has a lookup table for each of state transition modes, the lookup table relating a gradation level difference between luminance signals in sub-frames to an overdrive amount to be added, and
the addition means selects an appropriate overdrive amount, from a lookup table corresponding to a state transition mode determined by the determination means, thereby to determine the overdrive amount to be added onto the luminance signal subjected to the adaptive gray-scale conversion.

19. The image processing apparatus according to claim 15, wherein
the addition means has a lookup table for each of the state transition modes, the lookup table relating a gradation level difference between luminance signals in sub-frames to a gradation level of the luminance signal with an overdrive amount added, and
the addition means selects a gradation level of the luminance signal with an overdrive amount added, from a lookup table corresponding to a state transition mode determined by the determination means, thereby to determine the overdrive amount to be added onto the luminance signal subjected to the adaptive gray-scale conversion.

20. The image processing apparatus according to claim 15, wherein five state transition modes are defined as the plurality of state transition modes, where the five state transition modes are a state transition mode between the normal luminance states, a state transition mode from the normal luminance state to the low luminance state, a state transition mode from the low luminance state to the high luminance state, a state transition mode from the high luminance state to the low luminance state, and a state transition mode from the high luminance state to the normal luminance state.

21. The image processing apparatus according to claim 15, wherein five state transition modes are defined as the plurality of state transition modes, where the five state transition modes are a state transition mode between the normal luminance states, a state transition mode from the normal luminance state to the high luminance state, a state transition mode from the high luminance state to the low luminance state, a state transition mode from the low luminance state to the high luminance state, and a state transition mode from the low luminance state to the normal luminance state.

22. The image processing apparatus according to claim 15, wherein
seven state transition modes are defined as the plurality of state transition modes, where the seven state transition modes are a state transition mode between the normal luminance states, a state transition mode from the normal luminance state to the low luminance state, a state transition mode from the normal luminance state to the high luminance state, a state transition mode from the low luminance state to the high luminance state, a state transition mode from the high luminance state to the low luminance state, a state transition mode from the high luminance state to the normal luminance state, and a state transition mode from the low luminance state to the normal luminance state.

23. An image display comprising:
a detection means for detecting a motion index and/or an edge index of an input picture for each pixel;
a frame division means for dividing a unit frame period of the input picture into a plurality of sub-frame periods;
a gray-scale conversion means for selectively performing adaptive gray-scale conversion on a luminance in a pixel where a motion index and/or an edge index larger than a predetermined threshold value is detected by the detection means so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively;
a determination means for determining, one after another for each pixel, which state transition mode the transition mode of the luminance state of a pixel corresponds to among a plurality of state transition modes each defined as a state transition mode between any two of a normal luminance state, a high luminance state and a low luminance state, the normal luminance state being established by the original luminance signal not subjected to the adaptive gray-scale conversion by the gray-scale conversion means, the high luminance state being established in the high luminance period, the low luminance state being established in the low luminance period; and
an addition means for adding, for each pixel, an overdrive amount according to a determined state transition mode onto a luminance signal subjected to adaptive gray-scale conversion by the gray-scale conversion means; and
a display means for displaying a picture on the basis of a luminance signal subjected to addition of the overdrive amount by the addition means.

24. An image processing method comprising:
a detection step of detecting a motion index and/or an edge index of an input picture for each pixel;
a frame division step of dividing a unit frame period of the input picture into a plurality of sub-frame periods;
a gray-scale conversion step of selectively performing adaptive gray-scale conversion on a luminance signal in a pixel region where a motion index or an edge index larger than a predetermined threshold value is detected so that, while allowing the time integral value of the luminance signal within the unit frame period to be maintained as it is, a high luminance period having a luminance level higher than that of an original luminance signal and a low luminance period having a luminance level lower than that of the original luminance signal are allocated to sub-frame periods in the unit frame period, respectively;
a determination step of determining, one after another for each pixel, which state transition mode the transition mode of the luminance state of a pixel corresponds to among a plurality of state transition modes each defined as a state transition mode between any two of a normal luminance state, a high luminance state and a low luminance state, the normal luminance state being established by the original luminance signal not subjected to the adaptive gray-scale conversion, the high luminance state being established in the high luminance period, the low luminance state being established in the low luminance period; and
an addition step of adding, for each pixel, an overdrive amount according to a determined state transition mode onto a luminance signal subjected to adaptive gray-scale conversion.
